(19) United States
(12) Patent Application Publication
(10) Pub. No.: US 2026/0361528 A1
(43) Pub. Date: Nov. 12, 2026

(54) SECURE FILE SHARING METHODS, SYSTEMS, AND MEDIA INCLUDING GRANULAR ACCESS CONTROL FEATURES BASED ON USER AUTHENTICATION IN UNSECURE COMPUTING ENVIRONMENTS

(71) Applicant: Honeycake, Inc., Philadelphia, PA (US)

(72) Inventors: David William Luttrell, Philadelphia, PA (US); Monica Lynn Quigg, Westminster, MD (US); Christopher L. Chapman, New York, NY (US)

(21) Appl. No.: 19/673,255

(22) Filed: May 11, 2026

Related U.S. Application Data
(60) Provisional application No. 63/803,027, filed on May 9, 2025.

(51) Int. Cl. H04L 9/08; H04L 9/40

(52) U.S. Cl. CPC H04L 9/0861; H04L 63/0428

(57) ABSTRACT

The disclosed subject matter relates to secure file sharing methods, systems, and media including granular access control features based on user authentication in unsecure computing environments.

### CROSS-REFERENCE TO RELATED APPLICATIONS

This application claims the benefit of U.S. Provisional Patent Application No. 63/803,027, filed May 9, 2025, which is hereby incorporated by reference herein in its entirety.

### TECHNICAL FIELD

The disclosed subject matter relates to secure file sharing methods, systems, and media including granular access control features based on user authentication in unsecure computing environments.

### BACKGROUND

Allowing every user to view an entire document that includes confidential or sensitive data is typically neither appropriate nor necessary for each user to fulfill their specific roles. Existing systems, however, typically provide mechanisms for protection including generating multiple versions of the same document—e.g., one document with the confidential or sensitive data and another document with the confidential or sensitive data redacted or otherwise obscured, which creates confusion and increases costs and risks of disclosure. Alternatively, users can assign permissions, such as file permissions, folder permissions, and/or directory permissions, to access the entire document.

Existing techniques for sharing confidential or sensitive data generally include creating multiple manually-redacted files, with each version of the file having different portions redacted depending on the security clearance level of the intended recipients. Such techniques are manually intensive and prone to error.

Other techniques for encrypting documents typically operate by encrypting relatively large logical and physical structures. For example, whole disk encryption encrypts an entire storage device, while there are existing techniques for encrypting whole files. Such techniques include the encryption schemes built into various versions of the Windows operations system as well as third party compression tools. The primary limitation of these tools is that the entire document or physical device must be encrypted and decrypted as a whole. Using these tools, it is not possible to encrypt only a portion of, for example, a document.

Accordingly, it is desirable to provide new mechanisms for secure file sharing in unsecure computing environments that can include granular access control features based on user authentication.

### SUMMARY

Secure file sharing methods, systems, and media including granular access control features based on user authentication in unsecure computing environments are provided.

In accordance with some embodiments of the disclosed subject matter, a method for securely encrypting data containers in an unsecure environment is provided, the method comprising: receiving an encryption request for a file during an artificial intelligence session, where a server provides an interface between an encryption service and an artificial intelligence model and where the server is configured to allow a plurality of encryption operations performed by the encryption service to be called by the artificial intelligence model; determining a token associated with the artificial intelligence session between a local computing device and the artificial intelligence model; exchanging the token associated with the artificial intelligence session between the local computing device and the artificial intelligence model with an encryption-service-scoped token from the encryption service; transmitting, to the encryption service, a request for a plurality of hierarchically deterministic cryptographic keys that are derived from the encryption-service-scoped token, where each of the plurality of hierarchically deterministic cryptographic keys corresponds with a content portion identified as needing internal encryption and where the content portion is associated with user access information; and encrypting the content portion of the file associated with the artificial intelligence session using at least one of the plurality of hierarchically deterministic cryptographic keys that are derived from the encryption-service-scoped token.

In some embodiments, the content portion identified as needing internal encryption with a hierarchically deterministic cryptographic key from the plurality of hierarchically deterministic cryptographic keys further comprises: extracting structured content from the file; detecting, using a machine learning model that executes a named entity recognition technique, that the content portion contains content that is deemed to be sensitive content; classifying, using a large language model, the content within the detected content portion using a context-aware sensitivity assessment; and comparing the classified content against organization-specific policies to obtain evaluated content. In some embodiments, the method further comprises: generating a recommended encryption layer for further encrypting the file based on the evaluated content; and assigning a hierarchically deterministic key path for the content portion based on the recommended encryption layers, where the hierarchically deterministic cryptographic key used to encrypt the content portion is located at the hierarchically deterministic key path.

In some embodiments, the content portion identified as needing internal encryption with a hierarchically deterministic cryptographic key from the plurality of hierarchically deterministic cryptographic keys further comprises: rendering document content associated with at least a portion of the file on an interactive canvas interface; receiving user input defining a spatial region within the rendered document content presented on the interactive canvas interface; and generating a redaction manifest that maps the spatial region to a hierarchically deterministic key path, where the hierarchically deterministic cryptographic key used to encrypt the spatial region is located at the hierarchically deterministic key path.

In some embodiments, the method further comprises providing a markup language that receives a plurality of arbitrary markers that are placed within the file by a user of the local computing device, where the plurality of arbitrary markers indicate a starting point and an ending point of a layer of internal encryption within the file. In some embodiments, each of the plurality of arbitrary markers includes a first sequence of characters to indicate the starting point of the layer of internal encryption and a second sequence of characters to indicate the ending point of the layer of internal encryption.

In some embodiments, the method further comprises receiving an indication from a user of the local computing device of a layer of internal encryption within the file.

In some embodiments, the content portion identified as needing internal encryption with a hierarchically deterministic cryptographic key from the plurality of hierarchically deterministic cryptographic keys further comprises identifying content portions based on file type for at least one of page-level encryption, slide-level encryption, and field-level encryption.

In some embodiments, the user access information associated with a content portion within the file needing internal encryption is at least one of: a user identifier, an email address, a domain wildcard that identifies users at a domain, a universal wildcard that identifies authenticated users, and an organization group that identifies users associated with a group within an organization.

In some embodiments, the user access information associated with a content portion within the file needing internal encryption includes a deny rule that indicates users that are denied access to the content portion.

In some embodiments, each of the plurality of hierarchically deterministic cryptographic keys that are derived from the encryption-service-scoped token is wrapped by a key encryption key to form a wrapped key and the wrapped key is bound to an organization, the file that includes the content portion, and a field associated with the content portion based on additional authenticated data.

In some embodiments, the method further comprises transmitting user authentication information to an encryption server corresponding to the encryption service to initiate the encryption of the file.

In some embodiments, the user authentication information includes at least one of: an email address, a password, a personal identification number, a biometric credential, a magic link for passwordless email-based login, and a federated identity token.

In some embodiments, the encryption-service-scoped token is generated using a hierarchically deterministic encryption technique and acts as a master key. In some embodiments, the method further comprises encrypting, using the hierarchically deterministic encryption technique, the file using the master key.

In some embodiments, the method further comprises transmitting file information to the server that is associated with the encryption-service-scoped token corresponding to the encrypted file, where the file information includes a fingerprint of the file, a file name associated with the file, the encryption-service-scoped token that was received from the encryption server, a time-to-live value associated with the file, and an access tree corresponding to the one or more layers of internal encryption associated with the file and where the file information and the encryption-service-scoped token are associated in a key database associated with the server. In some embodiments, the fingerprint of the file is a checksum of the file generated by the local computing device.

In accordance with some embodiments of the disclosed subject matter, a system for securely encrypting data containers in an unsecure environment is provided, the system comprising a hardware processor that is configured to: receive an encryption request for a file during an artificial intelligence session, where a server provides an interface between an encryption service and an artificial intelligence model and where the server is configured to allow a plurality of encryption operations performed by the encryption service to be called by the artificial intelligence model; determine a token associated with the artificial intelligence session between a local computing device and the artificial intelligence model; exchange the token associated with the artificial intelligence session between the local computing device and the artificial intelligence model with an encryption-service-scoped token from the encryption service; transmit, to the encryption service, a request for a plurality of hierarchically deterministic cryptographic keys that are derived from the encryption-service-scoped token, where each of the plurality of hierarchically deterministic cryptographic keys corresponds with a content portion identified as needing internal encryption and where the content portion is associated with user access information; and encrypt the content portion of the file associated with the artificial intelligence session using at least one of the plurality of hierarchically deterministic cryptographic keys that are derived from the encryption-service-scoped token.

In accordance with some embodiments of the disclosed subject matter, a non-transitory computer-readable medium containing computer executable instructions that, when executed by a processor, cause the processor to perform a method for securely encrypting data containers in an unsecure environment is provided, the method comprising: receiving an encryption request for a file during an artificial intelligence session, where a server provides an interface between an encryption service and an artificial intelligence model and where the server is configured to allow a plurality of encryption operations performed by the encryption service to be called by the artificial intelligence model; determining a token associated with the artificial intelligence session between a local computing device and the artificial intelligence model; exchanging the token associated with the artificial intelligence session between the local computing device and the artificial intelligence model with an encryption-service-scoped token from the encryption service; transmitting, to the encryption service, a request for a plurality of hierarchically deterministic cryptographic keys that are derived from the encryption-service-scoped token, where each of the plurality of hierarchically deterministic cryptographic keys corresponds with a content portion identified as needing internal encryption and where the content portion is associated with user access information; and encrypting the content portion of the file associated with the artificial intelligence session using at least one of the plurality of hierarchically deterministic cryptographic keys that are derived from the encryption-service-scoped token.

In accordance with some embodiments of the disclosed subject matter, a method for securely encrypting data containers in an unsecure environment is provided, the method comprising: receiving, using a hardware processor of a local computing device, a selection of a file for encryption; transmitting user authentication information to an encryption server corresponding to an encryption service to initiate the encryption of the file; in response to authenticating a user account based on the user authentication information, receiving, from the encryption server, a master key that is associated with the file, where the master key is generated using a hierarchically deterministic encryption technique; determining whether one or more layers of internal encryption are needed for content portions within the file based on access control markers inserted within the file; in response to determining that one or more layers of internal encryption are needed for the content portions within the file, transmitting a request for corresponding cryptographic keys that are derived from the master key, where each cryptographic key corresponds with a content portion needing internal encryption and where each content portion needing internal encryption is associated with user access information; encrypting, using the hierarchically deterministic encryption technique, the file using the master key and each content portion within the file with the corresponding key that was derived from the master key to generate an encrypted file that is stored on the local computing device; and transmitting file information to the server that is associated with the master key corresponding to the encrypted file, where the file information includes a fingerprint of the file, a file name associated with the file, the master key that was received from the encryption server, a time-to-live value associated with the file, and an access tree corresponding to the one or more layers of internal encryption associated with the file and where the file information and the master key are associated in a key database associated with the encryption server.

In some embodiments, the fingerprint of the file is a checksum of the file generated by the local computing device.

In some embodiments, the method further comprises providing a markup language that receives a plurality of arbitrary markers that are placed within the file by a user of the local computing device, where the plurality of arbitrary markers indicate a starting point and an ending point of a layer of internal encryption within the file. In some embodiments, each of the plurality of arbitrary markers includes a first sequence of characters to indicate the starting point of the layer of internal encryption and a second sequence of characters to indicate the ending point of the layer of internal encryption.

In some embodiments, the method further comprises receiving an indication from a user of the local computing device of a layer of internal encryption within the file.

In some embodiments, the method further comprises automatically determining the content portions within the file for which internal encryption is set by a user of the local computing device.

In some embodiments, the user access information associated with a content portion within the file needing internal encryption is at least one of: a user identifier, an email address, a domain wildcard that identifies users at a domain, a universal wildcard that identifies authenticated users, and an organization group that identifies users associated with a group within an organization.

In some embodiments, the user access information associated with a content portion within the file needing internal encryption includes a deny rule that indicates users that are denied access to the content portion.

In some embodiments, the user authentication information includes at least one of: an email address, a password, a personal identification number, a biometric credential, a magic link for passwordless email-based login, and a federated identity token.

In accordance with some embodiments of the disclosed subject matter, a method for securely encrypting data containers in an unsecure environment is provided, the method comprising: receiving, using a hardware processor of a local computing device, a request to access an encrypted file; generating, using the hardware processor, a fingerprint of the encrypted file; transmitting, to an encryption server corresponding to an encryption service, user authentication information corresponding to a user using the local computing device and the fingerprint of the encrypted file, where the encryption server transmits a query to a key database that determines whether the fingerprint of the encrypted file matches previously stored fingerprints and that determines whether the user authentication information matches user access information associated with file information corresponding to a matching fingerprint; in response to determining that the user corresponding to the user authentication information is authorized to access one or more content portions of the encrypted file, receiving one or more cryptographic keys for decrypting the encrypted file; and decrypting the one or more content portions of the encrypted file using the one or more cryptographic keys for which the user of the local computing device has authorization to access.

In some embodiments, the local computing device receives a master key associated with the encrypted file that allows the user of the local computing device to decrypt the entire file and associated content portions.

In some embodiments, the fingerprint of the encrypted file is a checksum of the encrypted file generated by the local computing device.

In some embodiments, the user authentication information corresponding to the user using the local computing device includes at least one of: an email address, a password, a personal identification number, a biometric credential, a magic link for passwordless email-based login, and a federated identity token.

In accordance with some embodiments of the disclosed subject matter, a system for securely encrypting data containers in an unsecure environment is provided, the system comprising a hardware processor of a local computing device that is configured to: receive a selection of a file for encryption; transmit user authentication information to an encryption server corresponding to an encryption service to initiate the encryption of the file; in response to authenticating a user account based on the user authentication information, receive, from the encryption server, a master key that is associated with the file, where the master key is generated using a hierarchically deterministic encryption technique; determine whether one or more layers of internal encryption are needed for content portions within the file based on access control markers inserted within the file; in response to determining that one or more layers of internal encryption are needed for the content portions within the file, transmit a request for corresponding cryptographic keys that are derived from the master key, where each cryptographic key corresponds with a content portion needing internal encryption and where each content portion needing internal encryption is associated with user access information; encrypt, using the hierarchically deterministic encryption technique, the file using the master key and each content portion within the file with the corresponding key that was derived from the master key to generate an encrypted file that is stored on the local computing device; and transmit file information to the server that is associated with the master key corresponding to the encrypted file, where the file information includes a fingerprint of the file, a file name associated with the file, the master key that was received from the encryption server, a time-to-live value associated with the file, and an access tree corresponding to the one or more layers of internal encryption associated with the file and where the file information and the master key are associated in a key database associated with the encryption server.

In accordance with some embodiments of the disclosed subject matter, a system for securely encrypting data containers in an unsecure environment is provided, the system comprising a hardware processor of a local computing device that is configured to: receive a request to access an encrypted file; generate a fingerprint of the encrypted file; transmit, to an encryption server corresponding to an encryption service, user authentication information corresponding to a user using the local computing device and the fingerprint of the encrypted file, where the encryption server transmits a query to a key database that determines whether the fingerprint of the encrypted file matches previously stored fingerprints and that determines whether the user authentication information matches user access information associated with file information corresponding to a matching fingerprint; in response to determining that the user corresponding to the user authentication information is authorized to access one or more content portions of the encrypted file, receive one or more cryptographic keys for decrypting the encrypted file; and decrypt the one or more content portions of the encrypted file using the one or more cryptographic keys for which the user of the local computing device has authorization to access.

In accordance with some embodiments of the disclosed subject matter, a non-transitory computer-readable medium containing computer executable instructions that, when executed by a processor, cause the processor to perform a method for securely encrypting data containers in an unsecure environment is provided, the method comprising: receiving, using a hardware processor of a local computing device, a selection of a file for encryption; transmitting user authentication information to an encryption server corresponding to an encryption service to initiate the encryption of the file; in response to authenticating a user account based on the user authentication information, receiving, from the encryption server, a master key that is associated with the file, where the master key is generated using a hierarchically deterministic encryption technique; determining whether one or more layers of internal encryption are needed for content portions within the file based on access control markers inserted within the file; in response to determining that one or more layers of internal encryption are needed for the content portions within the file, transmitting a request for corresponding cryptographic keys that are derived from the master key, where each cryptographic key corresponds with a content portion needing internal encryption and where each content portion needing internal encryption is associated with user access information; encrypting, using the hierarchically deterministic encryption technique, the file using the master key and each content portion within the file with the corresponding key that was derived from the master key to generate an encrypted file that is stored on the local computing device; and transmitting file information to the server that is associated with the master key corresponding to the encrypted file, where the file information includes a fingerprint of the file, a file name associated with the file, the master key that was received from the encryption server, a time-to-live value associated with the file, and an access tree corresponding to the one or more layers of internal encryption associated with the file and where the file information and the master key are associated in a key database associated with the encryption server.

In accordance with some embodiments of the disclosed subject matter, a non-transitory computer-readable medium containing computer executable instructions that, when executed by a processor, cause the processor to perform a method for securely encrypting data containers in an unsecure environment is provided, the method comprising: receiving, using a hardware processor of a local computing device, a request to access an encrypted file; generating, using the hardware processor, a fingerprint of the encrypted file; transmitting, to an encryption server corresponding to an encryption service, user authentication information corresponding to a user using the local computing device and the fingerprint of the encrypted file, where the encryption server transmits a query to a key database that determines whether the fingerprint of the encrypted file matches previously stored fingerprints and that determines whether the user authentication information matches user access information associated with file information corresponding to a matching fingerprint; in response to determining that the user corresponding to the user authentication information is authorized to access one or more content portions of the encrypted file, receiving one or more cryptographic keys for decrypting the encrypted file; and decrypting the one or more content portions of the encrypted file using the one or more cryptographic keys for which the user of the local computing device has authorization to access.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example flow diagram of an illustrative process for encrypting a file with granular access control features in accordance with some embodiments of the disclosed subject matter.

FIG. 2 shows an illustrative dashboard user interface that can be presented to the user using a computing device in response to accessing the encryption application in accordance with some embodiments of the disclosed subject matter.

FIG. 3 shows an illustrative user interface for encrypting a file in accordance with some embodiments of the disclosed subject matter.

FIG. 4 shows an example flow diagram of an illustrative process for encrypting a file with granular access control features by a creator user and a corresponding process for decrypting and opening at least a portion of the encrypted file by a viewing user in accordance with some embodiments of the disclosed subject matter.

FIG. 5 shows an example flow diagram of an illustrative process for detecting sensitive content within a file for encryption and generating recommended encryption layers in accordance with some embodiments of the disclosed subject matter.

FIG. 6 shows an example flow diagram of an illustrative process for providing a visual redaction editor and mapping hierarchical deterministic keys to content portions corresponding to the regions selected using the visual redaction editor in accordance with some embodiments of the disclosed subject matter.

FIG. 7 is an illustrative example of hierarchically deterministic encryption pathways showing one or more cryptographic keys that are derived from a master key in accordance with some embodiments of the disclosed subject matter.

FIG. 8 shows an example flow diagram of an illustrative process for providing a key management system that combines envelope encryption features with hierarchically deterministic key derivation in accordance with some embodiments of the disclosed subject matter.

FIG. 9-11 show illustrative user interfaces that each include activity information that can be presented to the user using a computing device in response to accessing the encryption application in accordance with some embodiments of the disclosed subject matter.

FIG. 12 shows an example flow diagram of an illustrative process in which an encryption request is received from an artificial intelligence model in accordance with some embodiments of the disclosed subject matter.

FIG. 13 shows an example flow diagram of an illustrative process for opening and decrypting an encrypted file in accordance with some embodiments of the disclosed subject matter.

FIGS. 14 and 15 show illustrative user interfaces for decrypting an encrypted file in accordance with some embodiments of the disclosed subject matter.

FIG. 16 shows an illustrative example of multiple views of an encrypted file by different users based on different combinations of cryptographic keys and user authentication information in accordance with some embodiments of the disclosed subject matter.

FIGS. 17 and 18 show illustrative dashboard user interfaces that can be presented to the user using a computing device in response to accessing the encryption application in accordance with some embodiments of the disclosed subject matter.

FIG. 19 is an example block diagram of a system that can be used to implement mechanisms described herein in accordance with some implementations of the disclosed subject matter.

FIG. 20 is an example block diagram of hardware that can be used in a server and/or a user device in accordance with some implementations of the disclosed subject matter.

### DETAILED DESCRIPTION

In accordance with various embodiments of the disclosed subject matter, secure file sharing mechanisms (which can include methods, systems, and media) including granular access control features based on user authentication in unsecure computing environments are provided.

These secure file sharing mechanisms can perform various cryptographic functions, such as using a hierarchically deterministic encryption approach to generate cryptographic keys from a single master key. The master key can, for example, be unique to each encrypted file and, once a master key is generated by a secure file sharing system for association with a file, the secure file sharing system can derive one or more cryptographic keys from the master key, thereby providing additional layers of internal file encryption that can be created without the need to generate, store, and share an arbitrary number of new cryptographic keys. For example, such cryptographic keys that are derived from a master key can be used to further encrypt a portion of a file (e.g., a row of a spreadsheet, a section of an editable document, a portion of an image, etc.). This can provide, for example, multiple layers of encryption to safeguard files and other suitable data at rest and in transit. This can also allow, for example, multiple users to receive the same file simultaneously or asynchronously, where each user can have different levels of redaction based on user identity and/or user authentication.

In some embodiments, these secure file sharing mechanisms can provide users with granular access control features over content within each file. For example, a file creator can use a markup language to insert arbitrary markers or otherwise identify one or more content portions within a file as being subject to further security. In a more particular example, the markup language can instruct the file creator to insert an arbitrary marker (e.g., “~hc∥” to indicate the start of a section for applying additional encryption and “∥hc~” to indicate the end of the section for which additional encryption is to be applied). In another more particular example, the markup language can allow an encryption path, such as a hierarchically deterministic encryption path, to be placed in the arbitrary marker (e.g., “~hc-0-1∥CONTENT∥0-1-hc~” can indicate that “CONTENT” in a file is further encrypted by a cryptographic key that is located at 0′/1′ within a hierarchically deterministic encryption hierarchy).

It should be noted that, using these secure file sharing mechanisms, the secure file sharing system does not receive, analyze, or store a file that is to be encrypted. Instead, to open an encrypted file using the hierarchically deterministic encryption approach described herein, a computing device can send a checksum or any other suitable fingerprint information corresponding to the encrypted file to the secure file sharing server and user authentication information or any other suitable information that identifies the user attempting to open the encrypted file. In response, the secure file sharing server can transmit one or more cryptographic keys for the encrypted file to the computing device based on the user authentication information (e.g., what the particular user is authorized to view). It should be noted that a user seeking to access content within an encrypted file can be required to gain possession of the encrypted file (e.g., by transmission of the encrypted file from another user, such as the file creator) and gain access to content portions within the encrypted file based on one or more cryptographic keys provided by the secure file sharing server based on user authentication information.

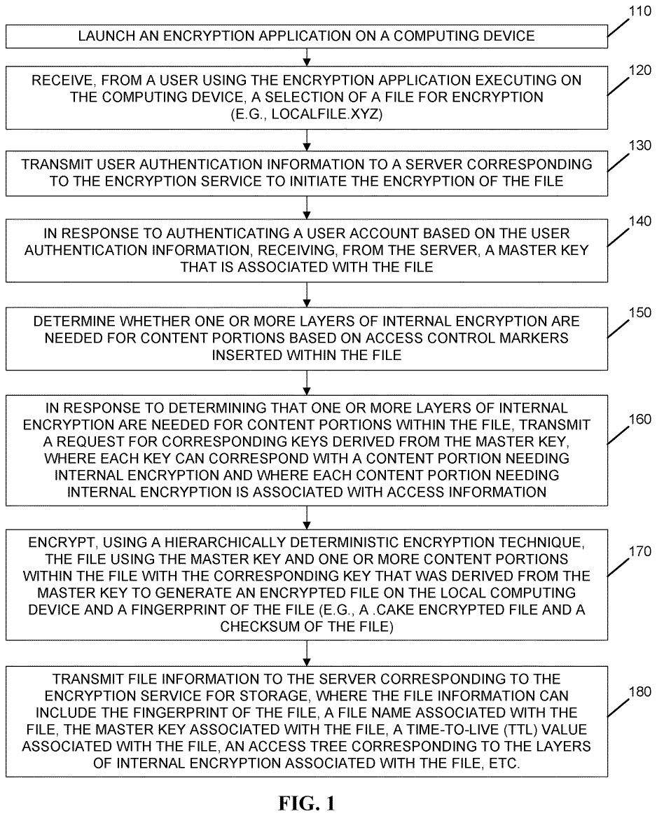

These and other features for providing secure file sharing mechanisms including granular access control features based on user authentication in unsecure computing environments are described further in connection with FIG. 1-20.

Turning to FIG. 1, an example flow diagram of an illustrative process 100 for encrypting a file with granular access control features in accordance with some embodiments of the disclosed subject matter is shown. In some embodiments, process 100 can be executed on any suitable device, such as one or more of the user devices 1908 discussed below in connection with FIG. 19.

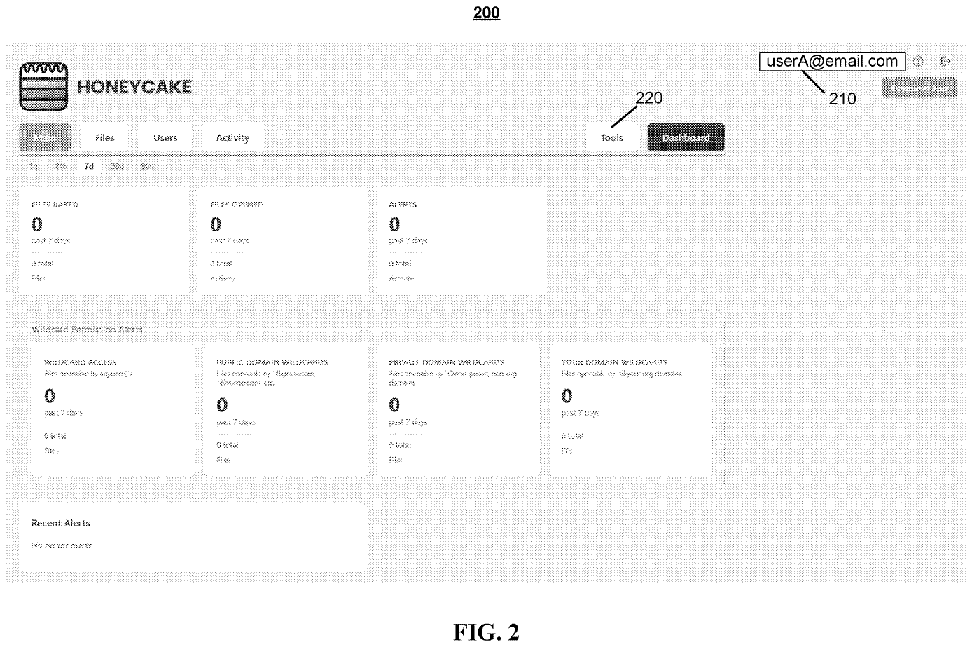

As shown, process 100 can begin at 110 by receiving instructions, from a user using a computing device, to launch an encryption application for encrypting a file, indicating content portions within the file for further encryption, indicating access control rights for each of the content portions, decrypting the file and the content portions for which the user has access rights, and/or viewing content portions within the file or the entirety of the file. Such instructions can include address information (e.g., a URI, a URL, a URN, an IP address, and/or any other suitable address information) where the encryption application can be downloaded, software corresponding to the encryption application, an indication of a pre-installed encryption application to launch, or any other suitable instructions to launch the encryption application. For example, such instructions can direct the computing device to launch the encryption application that has been downloaded and installed on the computing device. In another example, such instructions can direct the computing device to an application store and can initiate downloading the encryption application for installation and execution on the computing device. In yet another example, such instructions can direct the computing device to access a web-based or web-hosted encryption application. In a more particular example, FIG. 2 shows an illustrative dashboard user interface 200 that can be presented to the user having a user account 210 (e.g., userA@email.com) using the computing device in response to accessing a web-based or web-hosted encryption application.

It should be noted that, although the embodiments described herein generally show web-based user interfaces for the encryption application, the encryption application can be implemented as a desktop application, such as macOS or Windows (with MSIX packaging, file associations for .cake files or other encrypted files, protocol handlers, etc.), a mobile application, such as iOS (with QuickLook extension for encrypted file preview in the Files application) or Android (with share sheet integration), a web portal (e.g., React-based admin interface with client-side decryption via WebCrypto), a command-line interface (e.g., full CLI with bake/unbake/bakedir commands, JSON output, browser-based authentication, etc.), a system trap or menu bar (e.g., background encryption status and quick access on desktop platforms, etc.). That is, the encryption application can be implemented across multiple operating systems or environments.

In response to launching the encryption application on the computing device at 110, process 100 can continue by receiving, from a user using the encryption application executing on the computing device, a selection of a file for encryption at 120.

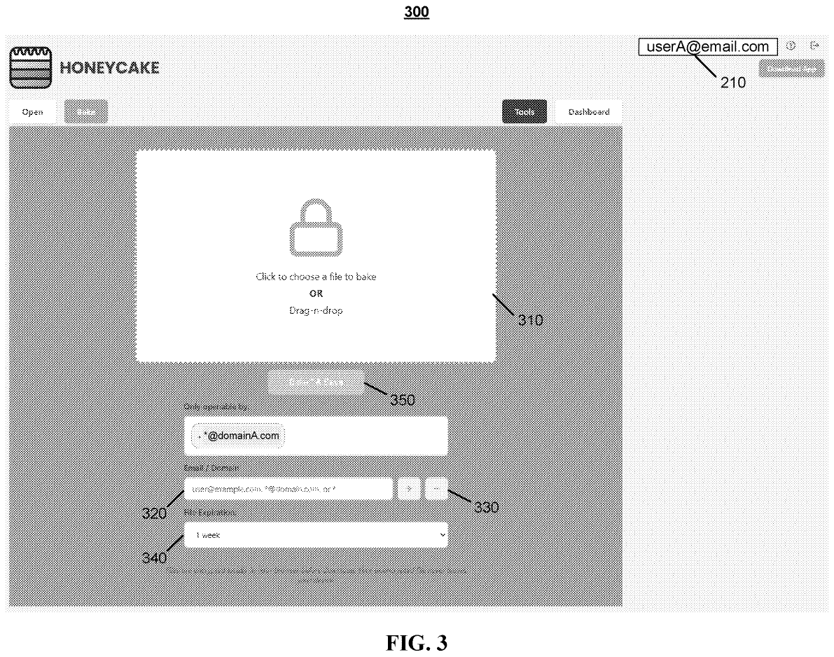

For example, in response to the user selecting a “Tool” button 220 or any other suitable user interface element in dashboard user interface 200 presented by the encryption application, the encryption application can present an encryption user interface 300 shown in FIG. 3 for encrypting at least a portion of the selected file. Encryption user interface 300 can include, for example, a file selection element 310 that allows a user to select a file for encryption (e.g., a file named “localfile.xyz”) and an access control element 320 that allows a user to provide user access information for opening the selected file (e.g., an email address).

It should be noted that, in addition to providing an email address as user access information in access control element 320, access control element 320 can receive any suitable user access information that identifies one or more users for opening the selected file. For example, user access information can include a domain wildcard, such as *@example.com, such that a user having an email address having the identified domain can be permitted to open the selected file. In another example, user access information can include a universal wildcard, such that all authenticated users of the encryption application can be permitted to open the selected file. In yet another example, user access information can include an organization group name, such as Engineering Team or any other suitable group identifier, where a user determined as belonging to the identified group can be permitted to open the selected file.

In some embodiments, the access control information entered in access control element 320 can be associated with a direction to grant or deny permission to open the selected file inputted using one or more direction interface elements 330. For example, a “+” or any other suitable grant identifier can be associated with the access control information (e.g., a particular domain wildcard) to indicate that the user grants users having user accounts that correspond to the access control information with permission to open the selected file. Alternatively, a “−” or any other suitable deny indicator can be associated with the access control information to indicate that the user denies users having user accounts that correspond to the access control information from opening the selected file. It should also be noted that a deny direction (e.g., a “−”) associated with the access control information can override a permission grant to open the selected file.

In some embodiments, for providing access control information in access control element 320, encryption user interface 300 can provide the user with the ability to select from one or more permission templates to apply to the access control information in access control element 320. Such permission templates can, for example, include one or more saved, reusable permission configurations that a user can apply to new documents or files with a single action.

In some embodiments, encryption user interface 300 can also include a timing interface element 340 that can allow the user to provide timing information associated with the grant or denial of permission to open the selected file. For example, as shown in FIG. 3, the user can select a time window in timing interface element 340 (e.g., one hour, one day, one week, one month, one year, etc.) for associating with the grant or denial of permission to open the selected file.

In response to selecting a file for encryption and providing access control information for opening the selected file, a direction to grant or deny permission to open the selected file that is associated with the access control information, and/or timing information associated with the access control information, encryption user interface 300 can include an encryption interface element 350 that, upon selection, allows the user to encrypt the selected file in file selection element 310, where the encrypted file can be opened upon meeting the provided access control information in access control element 320, the direction information in direction interface element 330, and the timing information in timing interface element 340.

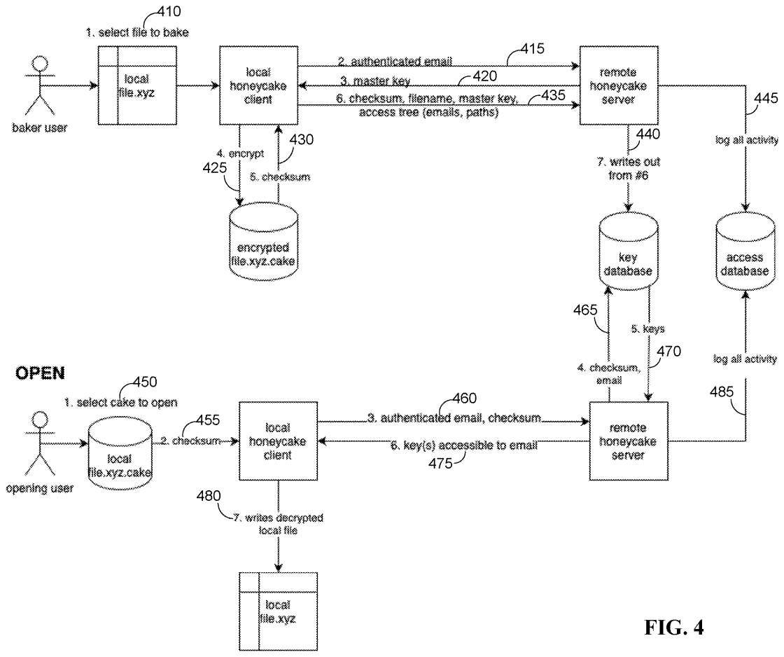

In another example, as shown in FIG. 4, a user using the encryption application executing on the computing device has selected a file named “localfile.xyz” to encrypt at 410. In a more particular example, in response to receiving a request to initiate the encryption of a file, the encryption application executing on a local client device can prompt the user to select a file (e.g., the “localfile.xyz” file) from files stored on the local client device.

It should be noted that, although the embodiments described herein generally describe the selection of a file to be encrypted as being stored on a computing device (e.g., a local computing device), this is merely illustrative and the file selected for encryption can be stored on any suitable storage device. For example, the file selected by the user for encryption can be stored on a storage device associated with a cloud storage service. In a more particular example, an OAuth connector framework or any other suitable authenticated connector can be provided that allows a user of the computing device to access files stored on a storage device associated with a third-party cloud storage service. In continuing this example, the file selected from the storage device associated with a third-party cloud storage service can be associated with OAuth tokens that are encrypted using Fernet symmetric encryption. In another example, the encryption application can support additional cloud storage services by providing provider-agnostic file import features, which can enable users of the encryption application to load, process, or otherwise ingest files using an application programming interface (API).

Referring back to FIG. 1, in some embodiments, process 100 can request that the user using the encryption application provide user authentication information with an encryption service to initiate the encryption of the file selected at 120. For example, the encryption application can request that the user using the encryption application provide user authentication information (e.g., a user name, an email address, a password, etc.) and/or any other suitable information that can be used to initiate a connection with the encryption service. As shown in FIGS. 2 and 3, a user having the user account userA@email.com has provided user authentication information that can be used to initiate a connection with the encryption service. As shown in FIG. 4, the user authentication information can be transmitted to an encryption server, a remote server, or any other suitable device associated with the encryption service for identifying the user at 415. It should be noted that, in this embodiment, other than user authentication information transmitted at 420, no proprietary information or data (e.g., a copy of the unencrypted file) is transmitted to the server in response to this request.

It should be noted that, although the embodiments described herein generally describe user authentication information as providing a user name (e.g., userA@email.com) and a password, this is merely illustrative and any suitable authentication approach can be used to accessing encryption keys, encrypting files, decrypting files, etc. For example, the encryption application can provide a multi-factor authentication approach in which the user is prompted to provide a user name and a password for primary authentication and subsequently prompted to provide a personal identification number (PIN), such as a 4-digit PIN, or a hardware key as a second form of authentication. In continuing this example, a progressive lockout features can be provided in which three or more authentication failures in inputting the PIN as a second form of authentication can result in a 15-minute lockout from the encryption application (or any other suitable time) and in which six or more authentication failures in inputting the PIN as a second form of authentication can result in a 60-minute lockout from the encryption application (or any other suitable time). In another example, the encryption application can provide a passwordless authentication approach in which the user is prompted to provide WebAuthn or biometric credential information (e.g., a face, a fingerprint, etc.) prior to presenting interfaces, such as encryption user interface 300 in FIG. 3. In yet another example, the encryption application can use an identity management approach, such as OAuth or SSO (single sign on), in which the user is prompted to sign in using federated identity information associated with a different identity domain (e.g., Google credentials, Microsoft credentials, Apple credentials, etc.) and where the different identity domain can coordinate and manage the authentication of the user with the encryption application across an identity infrastructure. In a further example, the encryption application can use a magic link authentication approach or any other suitable passwordless login approach in which the user is prompted to enter a user name, an email address, or a phone number to receive a unique, temporary, and secure link to access the encryption application.

In some embodiments, in response to authenticating the user of the computing device (e.g., based on an authenticated email address and password), process 100 can receive a master key from the encryption server at 140. For example, as shown in FIG. 4, in response to authenticating the user of the computing device and in response to receiving a request to encrypt a file stored on the computing device (e.g., selection of encryption interface element 350 in FIG. 3 in response to authenticating with the encryption application, selecting a file for encryption, entering access control information, entering timing information associated with the access control information, etc.), the encryption server can generate a single master key that is unique to the file stored on the computing device and can transmit the single master key to the computing device at 420.

It should be noted that the encryption server can generate a single master key that is unique to a particular file, where the master key can be used to generate, store, and/or share one or more additional cryptographic keys for further encrypting portions of the particular file. That is, the encryption server can derive one or more additional cryptographic keys from the single master key. For example, the encryption server can use a hierarchically deterministic encryption approach to generate one or more additional cryptographic keys from the single master key.

In response to receiving the master key from the encryption server at 140 and prior to encrypting the file using the master key, process 100 can determine whether one or more layers of internal encryption are needed for content portions within the file at 150. For example, a cryptographic key that is derived from the master key can be used to decrypt a content section. In continuing this example, a user that has permission to open the file but does not have access to the corresponding cryptographic key can view the file where the content section is blackened or otherwise redacted from being viewed.

It should be noted that any suitable content portion within the file can be encrypted with a cryptographic key that is hierarchically derived from the single master key.

For example, in the instance in which the file is a portable document format (PDF) file, process 100 can encrypt each individual PDF page of the PDF file with a distinct hierarchically determined key derived from the single master key, thereby providing page-level encryption for PDF files. In a more particular example, process 100 can detect each individual PDF page within the PDF file (e.g., based on page break properties, by visually inspecting thumbnail information, by analyzing document definitions or document layout information, etc.) and can encrypt each detected page with a distinct hierarchically determined key derived from the single master key. Alternatively, process 100 can prompt the user that selected the PDF file to indicate whether one or more pages within the PDF file should receive additional encryption.

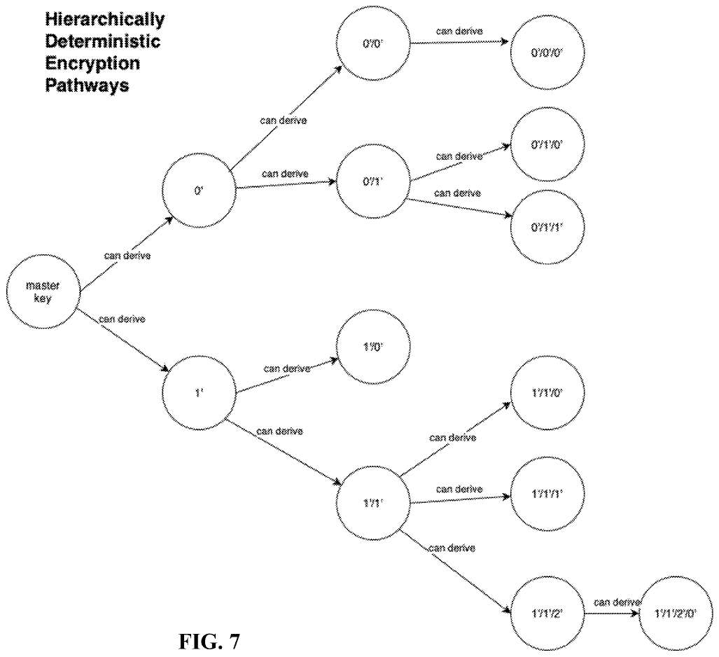

In another example, in the instance in which the file is a PowerPoint file (e.g., a PPTX file, a Google Slides file, etc.) or any other suitable presentation file, process 100 can encrypt each slide of the presentation file with a distinct hierarchically determined key derived from the single master key, thereby providing slide-level encryption for presentation files. In a more particular example, process 100 can automatically detect slide boundaries within the presentation file (e.g., based on slide properties, by visually inspecting the presentation file, etc.) and can encrypt each detected slide with a distinct hierarchically determined key derived from the single master key. In continuing this example, process 100 can detect whether each slide contains nested content within a slide and, in response to detecting nested content, can provide layered encryption for the slide, where the presentation file can be encrypted with a distinct hierarchically determined key derived from the single master key (e.g., the 0′ cryptographic key derived from the master key shown in FIG. 7), the slide of the presentation file can be further encrypted with a distinct hierarchically determined key derived from the single master key and the cryptographic key for the presentation file (e.g., the 0′/0′ cryptographic key derived from the master key and the 0′ cryptographic key for the presentation file shown in FIG. 7), and the nested content within the slide of the presentation can be further encrypted with a distinct hierarchically determined key derived from the single master key, the cryptographic key for the presentation file, and the cryptographic key for the slide on which the nested content is provided (e.g., the 0′/0′/0′ cryptographic key derived from the master key, the 0′ cryptographic key for the presentation file, and the 0′/0′ cryptographic key for the slide within the presentation file shown in FIG. 7).

In yet another example, in the instance in which the file contains structured text fields, process 100 can detect whether a file that has been selected for encryption includes one or more structured fields (e.g., in text files, in comma-separated values (CSV) files, etc.), thereby providing field-level encryption in files containing structured text fields. In a more particular example, process 100 can automatically detect and/or locate structured content boundaries within the text containing structured text fields and can encrypt each detected structured text field with a distinct hierarchically determined key derived from the single master key. In continuing this example, process 100 can retrieve a configuration file (e.g., a .hcrc configuration file) associated with the file containing structured text fields that the user has selected for encryption, where the configuration file can specify encryption permissions for particular structured text fields (e.g., fields having numerical data should be encrypted such that only users from the accounting department can be provided access). In response, process 100 can determine whether one or more structured fields or a section of structured fields (e.g., a column of financial data) is likely to contain financial data (or any other suitable type of data specified in the configuration file) and can encrypt the one or more structured fields in accordance with the configuration file (e.g., for access by users having accounts associated with the accounting department).

In some embodiments, process 100 can provide the user with a markup language that allows the user to insert arbitrary markers that indicate the beginning and the ending of a section that requires additional encryption and access control. For example, the user can use the markup language to insert an arbitrary marker, a delimiter, or any other suitable character or sequence of characters (e.g., “~hc∥”) to indicate the start of a section for applying additional encryption and access control and a corresponding arbitrary marker, delimiter, or any other suitable character or sequence of characters (e.g., “∥hc~”) to indicate the end of the section for which additional encryption and access control is to be applied. It should be noted that, although the arbitrary markers described herein generally include a sequence of characters to indicate the beginning of a content section for additional security and a mirrored-version of the sequence of characters to indicate the end of a content section receiving additional security, this is merely illustrative. For example, in some embodiments, the markup language can also include an encryption path, such as a hierarchically deterministic encryption path in which the corresponding cryptographic key is located within a hierarchically deterministic encryption hierarchy, such as “~hc-0-1∥CONTENT∥0-1-hc~” in which “CONTENT” located between the “~hc” and “∥” markers is further encrypted by a cryptographic key that is located at 0′/1′ within a hierarchically deterministic encryption hierarchy.

In some embodiments, alternatively to a markup language that uses arbitrary markers, delimiters, or other characters or sequences of characters to indicate a section of content for further encryption and access control, process 100 can allow the user to provide additional identifiers for content sections to receive additional encryption and/or access control. For example, in response to selecting a file (e.g., a Portable Document Format file), process 100 can provide the user with an option to indicate which pages should receive additional encryption and/or access control. In continuing this example, a user interface in association with the selected file can be generated on the computing device in which the user is prompted to select a page for further encryption and access control, in which the user is prompted to select or otherwise indicate a cryptographic key derived from the master key to use for further encrypting the selected page, in which the user is prompted to select or otherwise input user identifiers (e.g., email addresses) for one or more users having access to the content on the selected page, etc. In another example, in response to selecting a file, process 100 can provide the user with an option to visually indicate which content sections should receive additional encryption and/or access control. In continuing this example where the computing device includes a touch screen display or a touch-sensitive input pad, process 100 can allow the user using the computing device to indicate which content sections should receive additional encryption and/or access control using the touch screen display or the touch-sensitive input pad (e.g., receiving a user input that encircles a portion of content within the file). In response, the user can be prompted to indicate user identifiers (e.g., email addresses) for one or more users having access to the selected content (e.g., the computing device can provide a spoken audio prompt for receiving user identifiers to associate with the selected content).

In some embodiments, in response to selecting a file, process 100 can automatically divide the file into a number of content portions and can prompt the user to indicate whether one or more of the content portions should receive additional encryption and/or access control. For example, in response to selecting a file that is in Portable Document Format, process 100 can automatically divide the file into pages and can prompt the user to indicate whether one or more of the pages should receive additional encryption and/or access control. In another example, in response to selecting a file, process 100 can input the file into a machine learning model that outputs proposed content sections within the file based on boundaries, headers, keywords, and/or other indicators that are located within the file. In response, process 100 can prompt the user to verify whether the machine learning model correctly identified the content sections and whether one or more of the identified sections should receive additional encryption and/or access control. It should be noted that, in these embodiments, the unencrypted file is not transmitted to an external server or any other device outside of the computing device.

As described above, in response to the selected file being a slide presentation file, process 100 can automatically divide the file into a number of slide portions (e.g., each slide, a number of slides in a slide section, etc.) and can automatically encrypt each slide portion. Alternatively, process 100 can prompt the user to indicate whether one or more of the slide portions should receive additional encryption and/or access control.

As also described above, in response to determining that the selected file contains structured text fields, process 100 can automatically detect each structured text field and access a configuration file associated with the selected file to determine whether one or more of the structured text fields should receive additional encryption and/or access control. Alternatively, process 100 can automatically generate and assign a cryptographic key to each structured text field and then determine whether access should be restricted using the assigned cryptographic key to particular users based on the configuration file.

Additionally or alternatively, in some embodiments, the encryption mechanisms described herein can automatically detect sensitive content within a file to be encrypted and can generate recommended encryption layers. More particularly, machine learning models, such as language models, can be incorporated into the encryption mechanisms described herein to provide an automated system that detects sensitive content within a file that is to be encrypted and, in response, can generate a recommendation on encryption layers for the file.

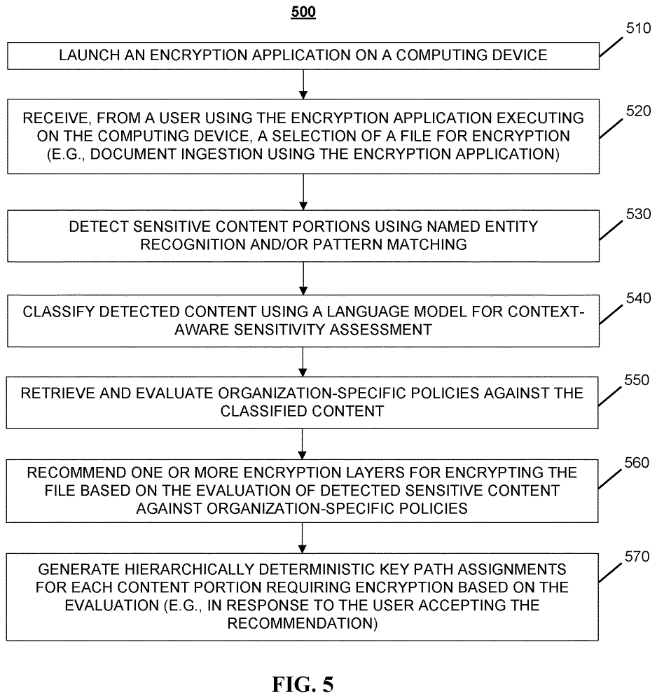

Turning to FIG. 5, an example flow diagram of an illustrative process 500 for detecting sensitive content within a file for encryption and generating recommended encryption layers in accordance with some embodiments of the disclosed subject matter is shown. In some embodiments, process 500 can be executed on any suitable device, such as one or more of the user devices 1908 discussed below in connection with FIG. 19.

Similar to 110 in FIG. 1, process 500 can begin at 510 by receiving instructions, from a user using a computing device, to launch an encryption application for encrypting a file, indicating content portions within the file for further encryption, indicating access control rights for each of the content portions, decrypting the file and the content portions for which the user has access rights, and/or viewing content portions within the file or the entirety of the file. Such instructions can include address information (e.g., a URI, a URL, a URN, an IP address, and/or any other suitable address information) where the encryption application can be downloaded, software corresponding to the encryption application, an indication of a pre-installed encryption application to launch, or any other suitable instructions to launch the encryption application. For example, such instructions can direct the computing device to launch the encryption application that has been downloaded and installed on the computing device. In another example, such instructions can direct the computing device to an application store and can initiate downloading the encryption application for installation and execution on the computing device. In yet another example, such instructions can direct the computing device to access a web-based or web-hosted encryption application. In a more particular example, FIG. 2 shows an illustrative dashboard user interface 200 that can be presented to the user having a user account 210 (e.g., userA@email.com) using the computing device in response to accessing a web-based or web-hosted encryption application.

Again, it should be noted that, although the embodiments described herein generally show web-based user interfaces for the encryption application, the encryption application can be implemented as a desktop application, such as macOS or Windows (with MSIX packaging, file associations for .cake files or other encrypted files, protocol handlers, etc.), a mobile application, such as iOS (with QuickLook extension for encrypted file preview in the Files application) or Android (with share sheet integration), a web portal (e.g., React-based admin interface with client-side decryption via WebCrypto), a command-line interface (e.g., full CLI with bake/unbake/bakedir commands, JSON output, browser-based authentication, etc.), a system trap or menu bar (e.g., background encryption status and quick access on desktop platforms, etc.). That is, the encryption application can be implemented across multiple operating systems or environments.

As described hereinbelow, alternatively to launching an encryption application at 510, the encryption application can be accessed in response to computing device interactions with an artificial intelligence model. For example, a computing device on which the encryption application has been installed can be interacting with an artificial intelligence model (e.g., an artificial intelligence assistant that is receiving conversational prompts from a user of the user device, where the artificial intelligence assistant determines that a file associated with the artificial intelligence session should be encrypted using the encryption application prior to transmission to another user; an artificial intelligence agent independently executing on the computing device can determine that a file associated with the artificial intelligence session should be encrypted using the encryption application prior to transmission to another user; etc.).

In response to launching the encryption application on the computing device at 510 or otherwise accessing the encryption application, process 500 can continue by receiving, from a user using the encryption application executing on the computing device, a selection of a file for encryption at 520.

For example, in response to the user selecting a “Tool” button 220 or any other suitable user interface element in dashboard user interface 200 presented by the encryption application, the encryption application can present an encryption user interface 300 shown in FIG. 3 for encrypting at least a portion of the selected file. Encryption user interface 300 can include, for example, a file selection element 310 that allows a user to select a file for encryption (e.g., a file named “localfile.xyz”) and an access control element 320 that allows a user to provide user access information for opening the selected file (e.g., an email address).

Alternatively, as described above, the file for encryption can be received from an artificial intelligence model on behalf of the user associated with the computing device on which the user is authorized to interact with the artificial intelligence model and the encryption service associated with the encryption application. For example, in response to an artificial intelligence model determining that a file is to be transmitted from the user of a computing device to a recipient user at a different computing device, the artificial intelligence model can interact with the encryption application (e.g., via a model context protocol server) to select the file for encryption prior to transmission to the recipient user at the different computing device.

In response to receiving the selected file for encryption, process 530 can detect sensitive content portions using one or more machine learning models configured to execute one or more natural language processing techniques to analyze and understand the content of the selected file to be encrypted, such as named entity recognition and/or pattern matching. It should be noted that, in some embodiments, the machine learning models that are used to analyze the selected file to be encrypted can be executed locally on the computing device (e.g., without transmitting the unencrypted file outside of the computing device).

For example, in some embodiments, process 500 can execute a machine learning model configured to execute a named entity recognition technique that can process unstructured data within the selected file for encryption into structured information that can be used to identify and/or classify entities (e.g., personally identifying information associated with one or more users, identifying information associated with groups of users, organization information, location information, financial information, date and time information, etc.). In a more particular example, named entities can be predefined categories of objects that are identifiable using named entity recognition techniques, where such categories can include person, organization, location, date or time, quantities, etc. In another more particular example, the named entity recognition technique can include analyzing the text appearing within the selected file (e.g., text in images using optical character recognition), determining text boundaries for further analyzing the context of the text appearing within the selected file (e.g., detecting capitalization, punctuation, bullet points or other item identifiers in a list, etc.), tokenizing text appearing within the selected file based on the text boundaries, image boundaries, and/or document information, identifying entities within the text that are associated with tokens or groups of tokens that match patterns of known entities, and classifying the identified entities within the text into a predefined category (e.g., person, organization, location, date or time, quantities, etc.).

At 540, process 500 can perform a context-aware sensitivity assessment on the detected content using one or more language models. This can, for example, increase the detection confidence of the entities within the text appearing in the selected file (e.g., where pattern matching alone using the named entity recognition technique by the machine learning model may be insufficient).

For example, in some embodiments, process 500 can execute a large language model configured to execute a context-aware sensitivity technique that can enhance the detection of entities by using the context of the text. In another example, in some embodiments, the large language model can also perform a sentiment analysis on the selected file to determine the sentiment expressed in portions of the selected file (e.g., positive, negative, neutral, a particular mood, etc.). In yet another example, in some embodiments, the large language model can perform an intent recognition analysis on the selected file to identify the purpose or goal of a portion within the selected file (e.g., the text describes making a request, the text is a question to the recipient user, the text is an answer that includes personally identifying information, etc.).

At 550, process 500 can retrieve organization-specific policies and evaluate the detected sensitive content against the organization-specific policies. For example, process 500 can interact with a policy engine, such as an open policy agent with multiple Rego policies, where process 500 can transmit a portion of sensitive content from the selected file and any other suitable information (e.g., contextual information, intent information, sentiment information, document information, etc.) as a query to the policy engine and where the policy engine can compare the portion of sensitive content against one or more organization-specific policies (e.g., all salary data in human resources documents must be encrypted at key path m/0′/1′).

At 560, process 500 can generate one or more recommended encryption layers for encrypting the selected file based on the evaluation of the detected sensitive content portions against organization-specific policies (e.g., using the policy engine described above). For example, prior to encrypting the selected file, process 500 can present a user interface that includes identified sensitive content (e.g., salary information for employee X), the organization-specific policy associated with the current recommendation (e.g., a rule stating that all salary data in human resources documents must be encrypted at key path m/0′/1′), and a recommended encryption layer (e.g., the sensitive content should appear redacted and encrypted with a cryptographic key at key path m/0′/1′ for access by users in the human resources department). Alternatively to prompting the user with one or more recommended encryption layers for further encrypting the selected file, process 500 can automatically accept the recommended encryption layers for encrypting the selected file.

At 570, process 500 can generate hierarchically deterministic key path assignments for each content portion requiring further encryption based on the evaluation. For example, in response to a user being presented with a user interface that includes a recommended encryption layer for a particular portion of sensitive content and in response to the user accepting the recommended encryption layer for that portion of sensitive content, process 500 can encrypt the sensitive content portion with a cryptographic key derived from the master key and located at the particular key path (e.g., key path m/0′/1′).

Additionally or alternatively, in some embodiments, the encryption mechanisms described herein can provide additional approaches for selecting content portions for further encryption and for mapping the content portions with a hierarchically deterministic cryptographic key derived from the master key and located at a particular key path.

For example, as described above in connection with 120 of FIGS. 1 and 520 of FIG. 5, the encryption application can receive a selection of a file for encryption at 520. For example, in response to the user selecting a “Tool” button 220 or any other suitable user interface element in dashboard user interface 200 presented by the encryption application, the encryption application can present an encryption user interface 300 shown in FIG. 3 for encrypting at least a portion of the selected file. Encryption user interface 300 can include, for example, a file selection element 310 that allows a user to select a file for encryption (e.g., a file named “localfile.xyz”) and an access control element 320 that allows a user to provide user access information for opening the selected file (e.g., an email address). Alternatively, as described above, the file for encryption can be received from an artificial intelligence model on behalf of the user associated with the computing device on which the user is authorized to interact with the artificial intelligence model and the encryption service associated with the encryption application. For example, in response to an artificial intelligence model determining that a file is to be transmitted from the user of a computing device to a recipient user at a different computing device, the artificial intelligence model can interact with the encryption application (e.g., via a model context protocol server) to select the file for encryption prior to transmission to the recipient user at the different computing device.

In response, the encryption mechanisms described herein can provide the user of the encryption application with a visual redaction editor with hierarchical deterministic key path mapping features. For example, the encryption mechanisms described herein can provide an interactive visual editor or any other suitable user interface that allows a user of the encryption application to open a file (e.g., a document) and draw encryption regions directly on the document content, where the encryption regions can be mapped to hierarchically deterministic key paths.

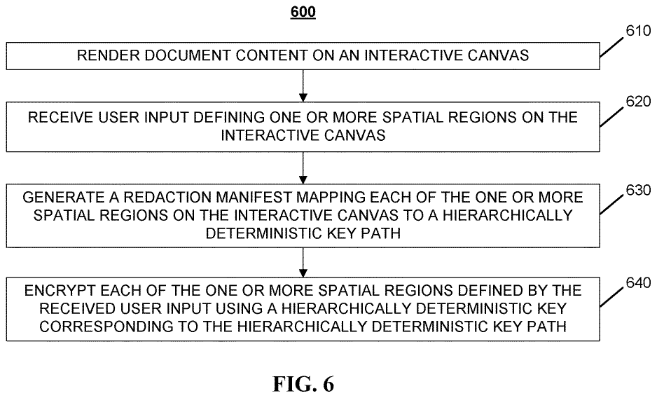

FIG. 6 shows an example flow diagram of an illustrative process 600 for providing a visual redaction editor and mapping hierarchical deterministic keys to content portions corresponding to the regions selected using the visual redaction editor in accordance with some embodiments of the disclosed subject matter. In some embodiments, process 600 can be executed on any suitable device, such as one or more of the user devices 1908 discussed below in connection with FIG. 19.

At 610, in some embodiments, process 600 can render the document content of the selected file on an interactive canvas. For example, in some embodiments, process 600 can generate a canvas user interface for presentation to the user of the computing device, where the canvas user interface includes a rendering of the document content associated with the selected file (e.g., a page of a PDF file, a slide of a presentation file, etc.) along with one or more selection tools (e.g., a highlight tool, a pointer tool, a pencil tool, etc.) for selecting a content portion within the selected file. In continuing this example, the user of the computing device can select one of the selection tools and, in response, the pointer in the canvas user interface can be modified to correspond with the selection tool selected by the user.

At 620, process 600 can receive a user input defining one or more spatial regions on the interactive canvas, where the one or more spatial regions correspond to content portions in the selected file. For example, using the selection tool in the canvas user interface, the user can select, draw, or encircle a spatial region around rendered content of the selected file in the interactive canvas, where the spatial region corresponds to a content portion within the selected file.

At 630, process 600 can determine the content portion that corresponds to the one or more special regions inputted by the user in the interactive canvas and can generate a redaction manifest model that maps each of the one or more spatial regions inputted by the user in the interactive canvas to a hierarchically deterministic key path. For example, in response to the user encircling a column showing employee salaries and a column showing social security numbers and other personally identifying information in another column of a spreadsheet, the redaction manifest model can be generated to cause a first content portion corresponding to a selected spatial region (e.g., a column showing employee salaries) to be redacted and a second content portion corresponding to another selected spatial region (e.g., a column showing social security numbers and other personally identifying information) to be redacted. In continuing this example, the redaction manifest model can map each of the redacted content portions to a hierarchically deterministic key path (e.g., the encircled column of content should appear redacted and encrypted with a cryptographic key at key path m/0′/1′ for access by users in the human resources department).

Alternatively to determining the content portion that corresponds to the one or more spatial regions inputted by the user in the interactive canvas, process 600 can generate an encryption layer assignment that includes a cryptographic key located at a hierarchically deterministic key path to spatial coordinates on the rendered document (e.g., coordinates that define the encircled region using the selection tool). That is, process 600 can create a region-to-key path binding where spatial coordinates on the rendered document are assigned to a cryptographic key located at a hierarchically deterministic key path.

At 640, process 600 can encrypt each content portion corresponding to the inputted spatial region or the inputted spatial region itself with a cryptographic key derived from the master key and located at the particular key path (e.g., key path m/0′/1′).

Referring back to FIG. 1, in response to determining that an additional content section within the file needs additional internal encryption, process 100 can determine the number of corresponding keys needed for the additional internal encryption at 160. Each cryptographic key can correspond with a content portion needing additional internal encryption and each content portion needing additional internal encryption can also be associated with user access information (e.g., user identifiers, email address, etc. for accessing the content portion). For example, the encryption application executing on the computing device can determine which content portions have been identified as needing additional internal encryption and/or access control and, in response, can determine a cryptographic key from the master key for associating with each of the identified content portions.

It should be noted that each content section that has been identified for additional internal encryption can be associated with one cryptographic key derived from the master key. It should also be noted that a content section can be identified within another content section with each section being associated with a cryptographic key. For example, if the file is a spreadsheet that includes a column of salary data, the entire content section that corresponds to the column of salary data can be further encrypted with a first cryptographic key derived from the master key while a particular cell of salary data can also be further encrypted with a second cryptographic key derived from the master key. Accordingly, in order to review the column of salary data including the particular cell of salary data, the viewing user needs to have access to both, which includes obtaining the first cryptographic key and the second cryptographic key both derived from the master key.

An illustrative example of the hierarchically deterministic encryption pathways showing cryptographic keys derived from a master key associated with a file is shown in FIG. 7. For example, as shown in FIG. 7, cryptographic keys 0′ and 1′ can be derived from the master key, where cryptographic keys 0′/0′ and 0′/1′ can be derived from cryptographic key 0′ and the master key. In another example, as also shown in FIG. 7, cryptographic keys 0′/1′/0′ and 0′/1′/1′ can be derived from cryptographic keys 0′/1′ and 0′ and the master key. In a more particular example, cryptographic keys 0′/1′/0′ and 0′/1′/1′ can be derived from cryptographic key 0′/1′, cryptographic key 0′/1′ can be derived from cryptographic key 0′, and cryptographic key 0′ can be derived from the master key.

It should be noted that each number in a pathway annotation can represent an order within a generation. For example, the cryptographic key located at 0′/0′/0′ can indicate that the cryptographic key is located at the first great-grandchild of the first grandchild of the first child from the master key. In another example, the cryptographic key located at 0′/1′/0′ can indicate that the cryptographic key is located at the first great-grandchild of the second grandchild of the first child from the master key.

It should also be noted that each cryptographic key provided by an encryption server to a user can be used to derive the cryptographic keys of their descendants in the hierarchically deterministic encryption hierarchy. It should further be noted that each cryptographic key provided by an encryption server to a user cannot be used to derive antecedent nodes of the hierarchically deterministic encryption hierarchy and cannot be used to derive cryptographic keys on different branches of the hierarchically deterministic encryption hierarchy.

In some embodiments, the encryption mechanisms described herein can provide a two-tier key management architecture that combines envelope encryption features with hierarchically deterministic key derivation.

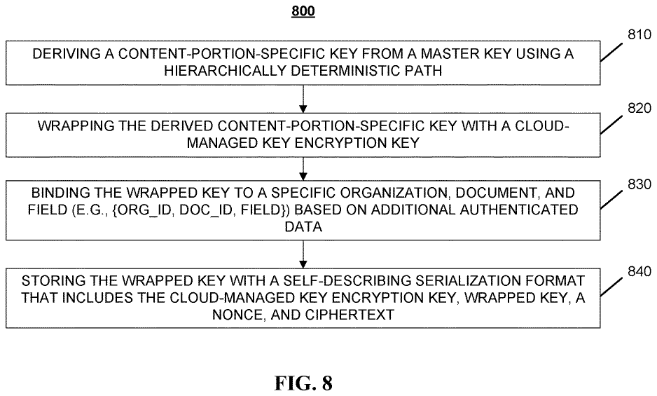

FIG. 8 shows an example flow diagram of an illustrative process 800 for providing a key management system that combines envelope encryption features with hierarchically deterministic key derivation in accordance with some embodiments of the disclosed subject matter. In some embodiments, process 800 can be executed on any suitable device, such as server 1902 discussed below in connection with FIG. 19. It should be noted that the server that includes the key management system can be different from the server that hosts the encryption application and the encryption service and/or the server that provides the model context protocol for connecting the encryption service with one or more artificial intelligence models.

Generally speaking, the disclosed subject matter relates to hierarchically deriving a content-portion-specific key (or a data encryption key) from a master key using a hierarchically deterministic key path, wrapping the content-portion-specific key with a cloud-managed key encryption key (e.g., which can be managed by a cloud hardware security module and never leaves the secure hardware) with anti-substitution additional authenticated data, thereby inhibiting an attacker from swapping wrapped keys between documents. This can, for example, bind each key to its specific document, organization, and field.

At 810, process 800 can derive a content-portion-specific cryptographic key from a master key using a hierarchically deterministic key path. For example, as described above in connection with 160 in FIGS. 1, 570 in FIG. 5, and 630 in FIG. 6, a hierarchically deterministic cryptographic key can be derived from a master key, where the cryptographic key can be located at a hierarchically deterministic key path. The cryptographic key can, for example, be used to locally encrypt a content portion within the selected file (e.g., a page in a PDF file, a slide in a presentation file, an encircled region within a document, a content portion that has been determined to include personally identifying information or other sensitive content information in accordance with organization-specific policies, etc.). It should be noted that the cryptographic key or any other suitable data encryption key can be generated locally per document or file.

At 820, process 800 can wrap the derived content-portion-specific cryptographic key with a cloud-managed key encryption key to form a wrapped cryptographic key. For example, process 800 can generate a key encryption key in a cloud key management system (KMS). Such a key encryption key can be managed by a cloud hardware security module and may never leave the secure hardware.

At 830, process 800 can bind the wrapped cryptographic key to additional authenticated data, such as a specific organization, a specific document, and a specific field. For example, each wrapped key can be bound to {org_id, doc_id, field}, thereby inhibiting an attacker from swapping wrapped keys between documents.

At 840, process 800 can store the wrapped key in a particular format that includes the cloud-managed key encryption key, the wrapped key, a nonce, and ciphertext. An illustrative example of the serialization format can be represented as:

ENC.v1:aes256gcm:<kms_uri>:<wrapped_dek>:<nonce>:<ciphertext+tag>

It should be noted that, in some embodiments, the cache of data encryption keys or hierarchically deterministic keys associated with content portions for further encryption can be a thread-safe least recently used (LRU) cache with configurable time-to-live (TTL), thereby ensuring data consistency and performance in concurrent encryption or decryption applications while managing memory.

It should also be noted that, in some embodiments, the migration from plaintext hierarchically deterministic cryptographic keys to envelope-encrypted hierarchically deterministic cryptographic keys can be backward compatible such that the user of the computing device can transform envelope-encrypted hierarchically deterministic cryptographic keys (in which a data encryption key is wrapped with a key encryption key to form a wrapped key and in which the wrapped key is further bound with additional authenticated data) back to a plaintext hierarchically deterministic cryptographic keys (e.g., based on user preferences set in the encryption application).

Referring back to FIG. 1, in some embodiments, in response to receiving the master key that is associated with the selected file at 140 and in response to generating additional cryptographic keys from the master key upon determining that one or more content portions within the file have been identified as needing further encryption and access control at 150 and 160, process 100 can encrypt, using a hierarchically deterministic encryption technique, the file using the master key and can encrypt the identified content portion using the corresponding cryptographic key that was generated and derived from the master key at 170. This is also shown in encryption step 425 in FIG. 4, where the encryption application can encrypt the file using a master key received from an encryption server in connection with the file and where the encryption application can use cryptographic keys derived from the master key to further encrypt one or more identified content portions within the file and where access control information (e.g., email addresses, user identifiers, etc.) are associated with each identified content portion (e.g., users with these email addresses can access content portion A). As also shown in FIG. 4, the encrypted file (e.g., the encrypted file named “file.xyz.cake” from the file named “file.xyz”) can be stored on a local storage device associated with the computing device.

It should be noted that the user (e.g., an owner of the encrypted file) can modify the access control information associated with content portions of the file or associated with the master key for receiving access to the entire file at any suitable time. For example, after encrypting the file, the user can revoke the access of a particular user account (e.g., a particular email address) to a particular content portion (e.g., the column that corresponds to private human resources information).

In some embodiments, in addition to encrypting the file using the master key and encrypting identified content portions within the file using cryptographic keys derived from the master key, process 100 can generate a checksum value, a hash value, or any other suitable fingerprint of the file. For example, the encryption application executing on the computing device can use a hashing function to generate a checksum value corresponding to the file. The hashing function can include a cryptographic hashing function (e.g., Secure Hash Algorithms (SHA-1, SHA-2, and SHA-3), Message-Digest Algorithms (MD2, MD4, MD5, and MD6), checksum functions, etc.), a cyclic redundancy check algorithm, a hash table (e.g., an associative array), a geometric hashing function, a one-to-one hashing function, etc. As shown in FIG. 2, a checksum value 230 can be generated using the encryption application.

Referring back to FIG. 1, at 180, file information corresponding to the encrypted file can be transmitted to the encryption server that corresponds to the encryption service, where such file information can be stored. It should be noted that file information, which can include the checksum value, the hash value, or any other suitable fingerprint of the file, the master key that was previously transmitted from the encryption server to the computing device in connection with the file, a time-to-live (TTL) associated with the file, an access tree corresponding to the layers of internal encryption associated with the file (e.g., such as the encryption paths shown in FIG. 7 along with access control information), etc., can be transmitted from the computing device to the encryption server, where the file information can be stored in a key database associated with the encryption server. This is also shown at 435 in FIG. 4, where the checksum value, the hash value, or any other suitable fingerprint of the file, the master key that was previously transmitted from the encryption server to the computing device in connection with the file, a time-to-live (TTL) associated with the file, an access tree corresponding to the layers of internal encryption associated with the file (e.g., such as the encryption paths shown in FIG. 5 along with access control information) is transmitted to the encryption server, where the file information is stored in a key database at 440.

It should be noted that, as described in the embodiments herein, the unencrypted file, the encrypted file, or any proprietary information stored on the computing device is not transmitted to the encryption server.

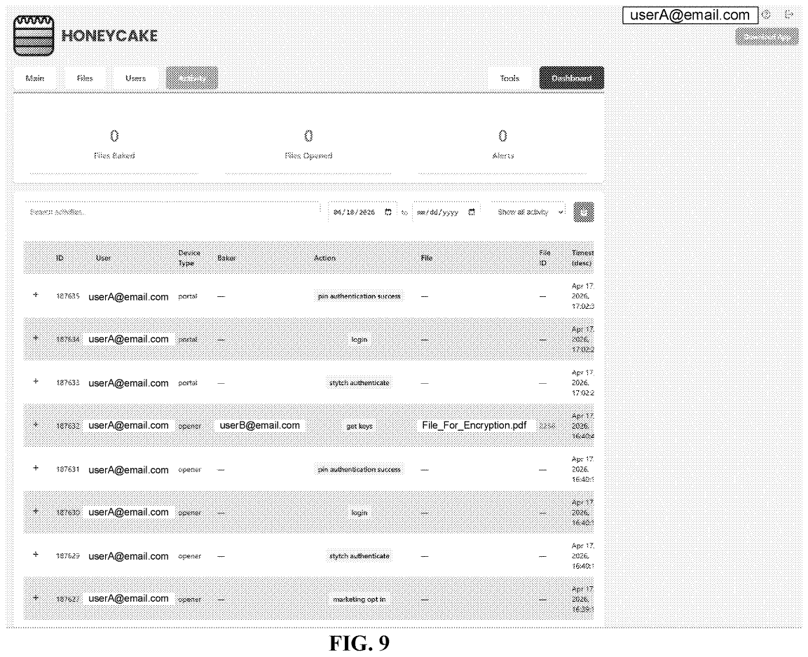

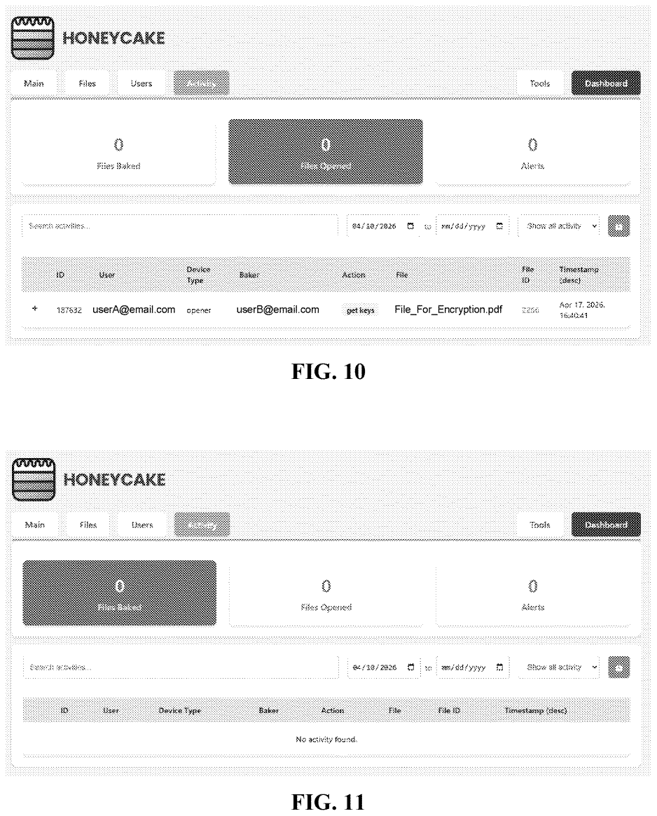

In some embodiments, process 100 can generate an activity log that includes any suitable activity, where the activity log can be stored in an access database. For example, as shown in FIG. 9, activity information, such as user login and authentication information, encryption application usage, file encryption information, master key generation information, and/or any other suitable activity information in connection with the encryption service can be stored in an access database at 445. In a more particular example, FIG. 9 shows an illustrative example of an activity log interface being presented by the encryption application in which the activity log interface includes an action (e.g., pin authentication, login, obtaining keys to decrypt a file, etc.), a user that performed the action (e.g., userA@email.com), a user that encrypted the file being accessed (e.g., userB@email.com), a device type associated with the activity or action, a file name corresponding to the file being accessed, a file identifier corresponding to the file being accessed, a timestamp associated with the activity or action, a transaction identifier associated with the activity or action, etc. This is also shown in FIG. 10, which shows an activity log interface presented by the encryption application that includes activity information for files decrypted and opened by a user, and FIG. 11, which shows an activity log interface presented by the encryption application that includes activity information for files selected and encrypted for the user using the encryption application.

It should be noted that, in some embodiments, the encryption application can implement a transactional outbox pattern in which audit entries can be atomically co-committed with business operations, thereby guaranteeing that there are no audit gaps even during crashes.

It should also be noted that, in some embodiments, each audit entry can be associated with an idempotency key, thereby inhibiting duplicate records from being stored in the activity log.

It should further be noted that the activity log can provide real-time bidirectional communication between a computing device executing the encryption application and a server (e.g., a WebSocket-based live activity feed).

In some embodiments, in connection with the activity log, process 100 can further perform a compliance validation in which an automated and scheduled checks of the activity log can be performed to ensure activity log integrity and permission consistency.

Although the embodiments described herein generally describe the encryption or decryption of a file being initiated by a user using an encryption application (e.g., encryption user interface 300 in FIG. 3), this is merely illustrative. In some embodiments, the user can be using an artificial intelligence assistant having a conversational or chat interface (e.g., GPT-4 by OpenAI, CLAUDE by Anthropic, PaLM 2 and Gemini by Google DEEPMIND, LLAMA by Meta, etc.), where the artificial intelligence assistant can use the encryption application via a tool interface to encrypt or decrypt a file on behalf of the user (e.g., a file stored locally on a user device, a file stored in a cloud storage device and associated with a user account corresponding to the user, etc.). In some embodiments, the user device can execute an artificial intelligence agent that can automatically use the encryption application via a tool interface to encrypt or decrypt a file on behalf of the user (e.g., in response to attaching a file to an email message, the artificial intelligence agent can connect with the encryption application and can instruct the encryption application to encrypt the file with access control to the recipient of the email message, where the encrypted file can replace the file attached to the email message being sent to the recipient). That is, some embodiments of the disclosed subject matter can provide artificial intelligence-integrated encryption that allows an artificial intelligence model to perform granular file encryption and/or decryption on behalf of users via a model context protocol.

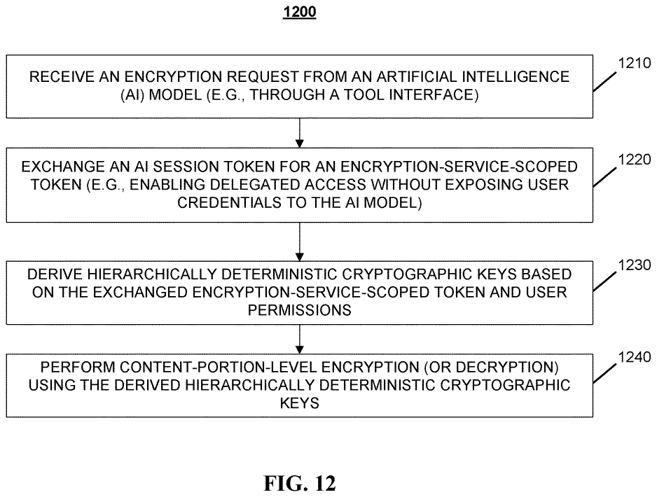

FIG. 12 shows an example flow diagram of an illustrative process 1200 in which an encryption request is received from an artificial intelligence model in accordance with some embodiments of the disclosed subject matter. In some embodiments, process 1200 can be executed on any suitable device, such as user device 1906 that may be interacting with an artificial intelligence service and an encryption service.

In some embodiments, a user using one or more of the user devices 1906 discussed below in connection with FIG. 19 can be interacting with an artificial intelligence model (e.g., via a chat or conversational interface) or user device 606 can be configured to execute an artificial intelligence agent. For example, a computing device on which the encryption application has been installed can be interacting with an artificial intelligence model (e.g., an artificial intelligence assistant that is receiving conversational prompts from a user of the user device, where the artificial intelligence assistant determines that a file associated with the artificial intelligence session should be encrypted using the encryption application prior to transmission to another user; an artificial intelligence agent independently executing on the computing device can determine that a file associated with the artificial intelligence session should be encrypted using the encryption application prior to transmission to another user; etc.).

At 1210, process 1200 can receive an encryption request from an artificial intelligence model. For example, a computing device on which the encryption application is installed can be interacting with an artificial intelligence model—e.g., where the user of the computing device is interacting with an artificial intelligence assistant that is receiving conversational prompts from the user and, in response to the conversational prompts, the artificial intelligence assistant has determined that a file attached to an artificial intelligence session should be encrypted prior to transmission to a recipient user; where the computing device has an artificial intelligence agent independently executing on the computing device, where the artificial intelligence agent running one or more artificial intelligence models has determined that a file should be encrypted prior to transmission to a recipient user. In response, the artificial intelligence model can detect that the encryption application has been installed on the computing device and that the encryption application should be used to encrypt the file prior to transmission to the recipient user.

It should be noted that a model context protocol server or any other suitable server can provide an interface between the encryption service provided by the encryption application and one or more artificial intelligence models. For example, the model context protocol server can expose or otherwise make available multiple encryption operations (e.g., bake, unbake, transfer, etc.) as callable tools by each of the artificial intelligence models. In continuing this example, the model context protocol server can allow an artificial intelligence model to perform a bake or encryption operation by the encryption service in response to determining that a file encryption is needed. It should also be noted that the model context protocol server or any other suitable server can self-register with the encryption service, thereby allowing client credentials to be received programmatically.

At 1220, in response to receiving the encryption request from the artificial intelligence model, process 1200 can determine a token associated with the artificial intelligence session between the computing device and the artificial intelligence model and can exchange the token associated with the artificial intelligence session for an encryption-service-scoped token. For example, process 1200 can generate a token using a portal associated with the artificial intelligence model. In another example, process 1200 can use a helper function to fetch a stored token associated with the artificial intelligence session. In continuing this example, upon retrieving the token associated with the artificial intelligence session between the computing device and the artificial intelligence model, process 1200 can trade the token associated with the artificial intelligence session for a new token—e.g., an encryption-service-scoped token via an OAuth 2.1 token exchange. This can, for example, enable delegated access without exposing user credentials to the artificial intelligence model.

At 1230, multiple hierarchically deterministic cryptographic keys can be derived from the encryption-service-scoped token and user permissions. For example, as described above in connection with 160 in FIGS. 1, 570 in FIG. 5, and 630 in FIG. 6, a hierarchically deterministic cryptographic key can be derived from a master key, where the cryptographic key can be located at a hierarchically deterministic key path. The cryptographic key can, for example, be used to locally encrypt a content portion within the selected file (e.g., a page in a PDF file, a slide in a presentation file, an encircled region within a document, a content portion that has been determined to include personally identifying information or other sensitive content information in accordance with organization-specific policies, etc.). It should be noted that the cryptographic key can be generated locally per document or file.

At 1240, in response to exchanging the token associated with the artificial intelligence session for an encryption-service-scoped token and deriving multiple hierarchically deterministic cryptographic keys from the encryption-service-scoped token, process 1240 can encrypt, using a hierarchically deterministic encryption technique, the file associated with the artificial intelligence session using the encryption-service-scoped token and can encrypt identified content portions within the file using corresponding cryptographic key that was generated and derived from the encryption-service-scoped token.

Referring back to FIG. 1 that generally described an illustrative process for encrypting a file and/or further encrypting content portions within the file, it should be noted that the embodiments described herein can also be used to decrypt an encrypted file in which different users can be provided with access to different content portions within the encrypted file that have been further encrypted.

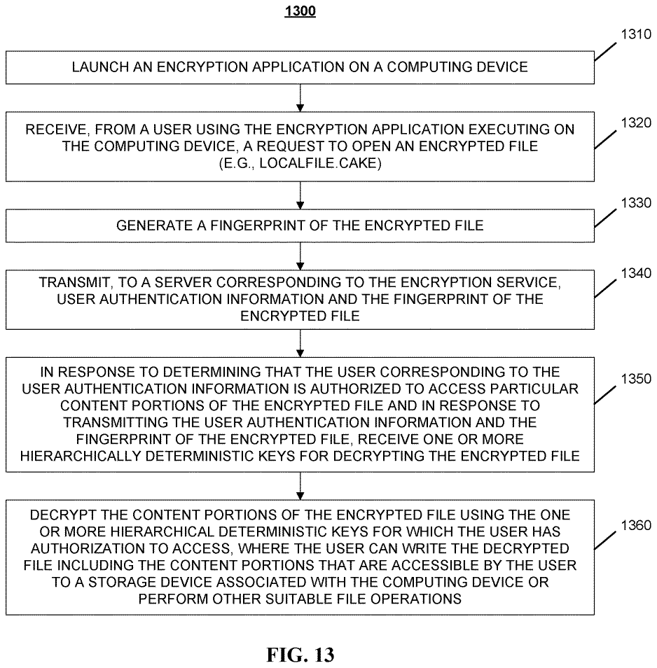

Turning to FIG. 13, an example flow diagram of an illustrative process 1300 for opening and decrypting an encrypted file in accordance with some embodiments of the disclosed subject matter is shown. In some embodiments, process 1300 can be executed on any suitable device, such as one or more of the user devices 1908 discussed below in connection with FIG. 19.

As shown, process 1300 can begin at 1310 by receiving instructions, from a user using a computing device, to launch an encryption application for opening and decrypting an encrypted file, providing user authentication information for accessing content portions within a file that have received additional encryption, viewing content portions within the file or the entirety of the file for which the user has access control rights, etc. Such instructions can include address information (e.g., a URI, a URL, a URN, an IP address, and/or any other suitable address information) where the encryption application can be downloaded, software corresponding to the encryption application, an indication of a pre-installed encryption application to launch, or any other suitable instructions to launch the encryption application. For example, such instructions can direct the computing device to launch the encryption application that has been downloaded and installed on the computing device. In another example, such instructions can direct the computing device to an application store and can initiate downloading the encryption application for installation and execution on the computing device. In yet another example, such instructions can direct the computing device to access a web-based or web-hosted encryption application.

Again, it should be noted that, although the embodiments described herein generally show web-based user interfaces for the encryption application, the encryption application can be implemented as a desktop application, such as macOS or Windows (with MSIX packaging, file associations for .cake files or other encrypted files, protocol handlers, etc.), a mobile application, such as iOS (with QuickLook extension for encrypted file preview in the Files application) or Android (with share sheet integration), a web portal (e.g., React-based admin interface with client-side decryption via WebCrypto), a command-line interface (e.g., full CLI with bake/unbake/bakedir commands, JSON output, browser-based authentication, etc.), a system trap or menu bar (e.g., background encryption status and quick access on desktop platforms, etc.). That is, the encryption application can be implemented across multiple operating systems or environments.

In response to launching the encryption application on the computing device at 1310, process 1300 can continue by receiving, from a user using the encryption application executing on the computing device, a selection of an encrypted file for viewing or otherwise decrypting at 1320.

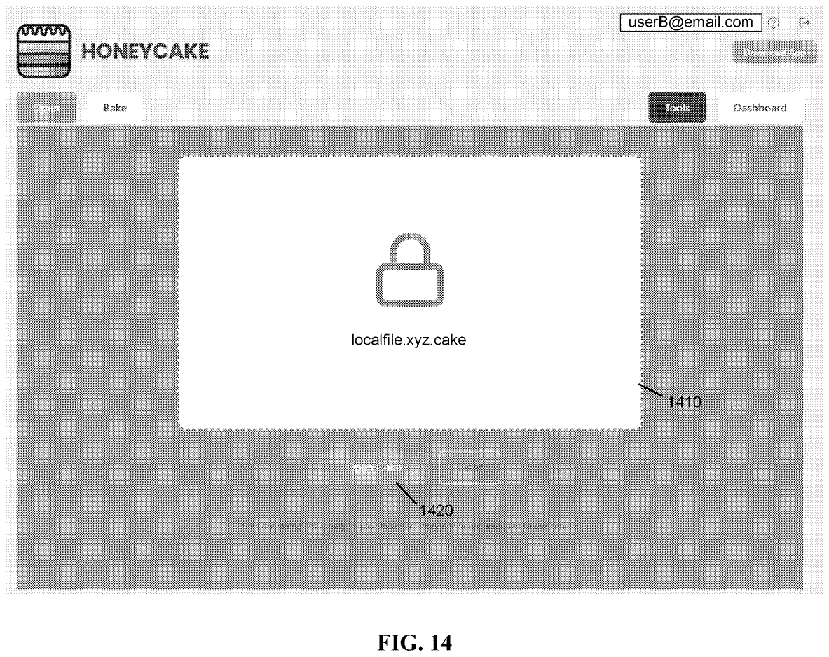

For example, in response to the user accessing a portal associated with the encryption application, selecting an “Open” interface element, or any other suitable user interface element in a user interface presented by the encryption application, the encryption application can present a decryption user interface 1400 shown in FIG. 14 for decrypting at least a portion of the selected file. Decryption user interface 1400 can include, for example, a file ingestion element 1410 that allows a recipient user to select a file for decryption (e.g., a file named “localfile.xyz.cake”) and an open interface element 1420 that causes the encryption service to initiate the decryption of the encrypted file at 1410 based on the master key and cryptographic keys associated with the recipient user having particular user authentication information (e.g., an email address, an email address indicating that the user belongs to a particular domain, a user identifier indicating that the user belongs to a particular organization).

In another example, as shown in FIG. 4, a user using the encryption application executing on the computing device has received an encrypted file named “file.xyz.cake” and has selected the encrypted file to decrypt at 450. In a more particular example, in response to receiving a request to initiate the decryption of an encrypted file, the encryption application executing on a local client device can prompt the user to provide user authentication information (e.g., an email address or other user identifier that has access to open the encrypted file) and can prompt the user to select the encrypted file (e.g., the “file.xyz.cake” file) from files stored on the local client device.

Although the embodiments described herein generally describe the decryption of an encrypted file as being initiated by a recipient user using an encryption application (e.g., decryption user interface 1400 in FIG. 14), this is merely illustrative. In some embodiments, the user can be using an artificial intelligence assistant having a conversational or chat interface (e.g., GPT-4 by OpenAI, CLAUDE by Anthropic, PaLM 2 and Gemini by Google DEEPMIND, LLAMA by Meta, etc.), where the artificial intelligence assistant can use the encryption application via a tool interface to decrypt a file on behalf of the user (e.g., an encrypted file stored locally on a user device, an encrypted file stored in a cloud storage device and associated with a user account corresponding to the user, etc.). In some embodiments, the user device can execute an artificial intelligence agent that can automatically use the encryption application via a tool interface to decrypt a file on behalf of the user (e.g., in response to receiving an encrypted file in an email message, the artificial intelligence agent can connect with the encryption application and can instruct the encryption application to decrypt the file, where the decrypted file can replace the file attached to the email message received by the recipient user). That is, some embodiments of the disclosed subject matter can provide artificial intelligence-integrated decryption that allows an artificial intelligence model to perform granular file decryption on behalf of users via a model context protocol (such as the model context protocol described in connection with FIG. 12).

In some embodiments, process 1300 can continue by generating a fingerprint of the encrypted file using the encryption application executing on the computing device at 1330. For example, in response to selecting an encrypted file to open using the encryption application, process 1300 can generate a checksum value, a hash value, or any other suitable fingerprint of the encrypted file. In a more particular example, the encryption application executing on the computing device can use a hashing function to generate a checksum value corresponding to the file. The hashing function can include a cryptographic hashing function (e.g., Secure Hash Algorithms (SHA-1, SHA-2, and SHA-3), Message-Digest Algorithms (MD2, MD4, MD5, and MD6), checksum functions, etc.), a cyclic redundancy check algorithm, a hash table (e.g., an associative array), a geometric hashing function, a one-to-one hashing function, etc. As shown in FIG. 4, a checksum value 455 can be generated using the encryption application in connection with an encrypted file that was selected by the user at 450.

As described above, in some embodiments, process 1300 can request that the user using the encryption application provide user authentication information with an encryption service to determine the access rights associated with the user in decrypting the file selected at 1320. For example, the encryption application can request that the user using the encryption application provide user authentication information (e.g., a user name, an email address, a password, etc.) and/or any other suitable information that can be used to initiate a connection with the encryption service. As shown in FIG. 4, user authentication information along with the checksum value or any other suitable fingerprint of the encrypted file can be transmitted to an encryption server, a remote server, or any other suitable device associated with the encryption service for identifying the user at 460. It should be noted that, in this embodiment, other than user authentication information transmitted at 460, no proprietary information or data (e.g., a copy of the encrypted file) is transmitted to the server in response to this request.

In some embodiments, in response to transmitting the user authentication information and the fingerprint of the encrypted file to the encryption server corresponding to the encryption service, process 1300 can transmit a query to a key database, where the query can include the user authentication information and the fingerprint of the encrypted file at 1330. For example, as shown in FIG. 4, the encryption server can transmit, at 465, a query that includes a checksum value and an email address corresponding to the user attempting to decrypt and/or open an encrypted file. In continuing this example, in response to the key database determining that the checksum value matches a checksum value that is associated with an encrypted file and that was previously stored in the key database and in response to the key database determining that the email address is associated with the previously stored checksum value in which the user account corresponding to the email address is provided with at least partial access to the encrypted file (e.g., one content portion, multiple content portions, the entire file, etc.), the encryption server can determine the corresponding cryptographic keys to transmit to the user account at 470. In a more particular example, the key database can determine whether the checksum value received from the user corresponding to a request to open an encrypted file at 465 matches a previously stored checksum value associated with a previously encrypted file and, in response to matching the received checksum value with a previously stored checksum value, the key database can determine whether the email address or any other suitable user authentication information is associated with one or more content portions or the entire file, where the corresponding keys (e.g., a master key or one or more cryptographic keys derived from the master key) can be transmitted as a response to the query from the encryption server.

Referring back to FIG. 13, in response to determining that the user corresponding to the user authentication information is authorized to access particular content portions of the encrypted file and in response to transmitting the user authentication information and the fingerprint of the encrypted file to the encryption server (e.g., in which the fingerprint of the encrypted file matches a previously stored fingerprint), process 1300 can receive one or more hierarchically deterministic keys for decrypting at least a portion of the encrypted file. For example, as shown in FIG. 4, the one or more cryptographic keys that are accessible to the email address or any other suitable user authentication information can be transmitted to the computing device in which the encryption application is currently being executed.

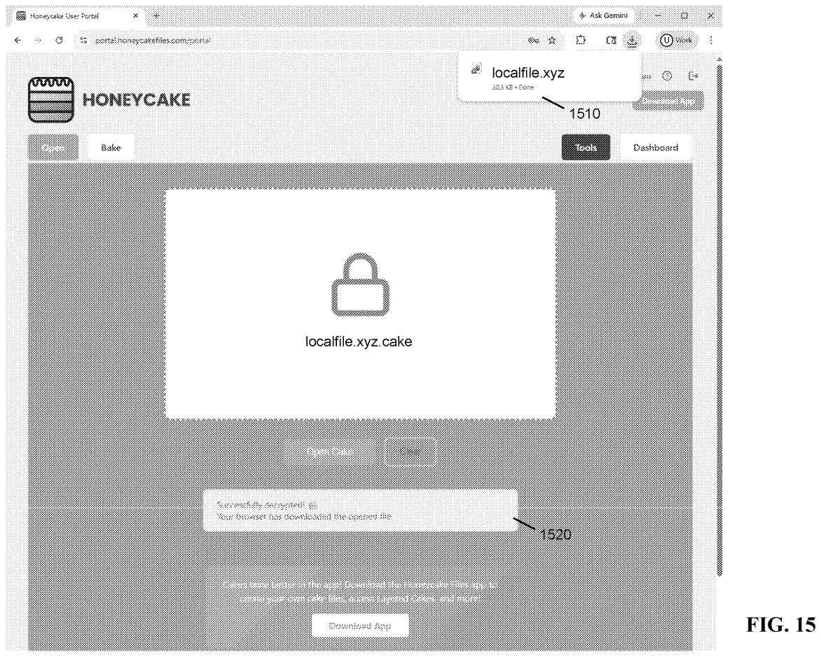

At 1360, process 1300 can, in turn, decrypt the content portions of the encrypted file using the one or more hierarchically deterministic keys for which the user has authorization to access, where the user can write the decrypted file including the content portions that are accessible by the user to a storage device associated with the computing device or perform other suitable file operations. For example, as shown in FIG. 15, the decrypted file can be automatically stored in a storage device associated with the computing device of the recipient, which is shown by download indicator 1510 and confirmation message 1520. In another example, as shown in FIG. 4, the decrypted file can be written as a local file named “file.xyz” using the one or more hierarchically deterministic keys received from the encryption server at 480.

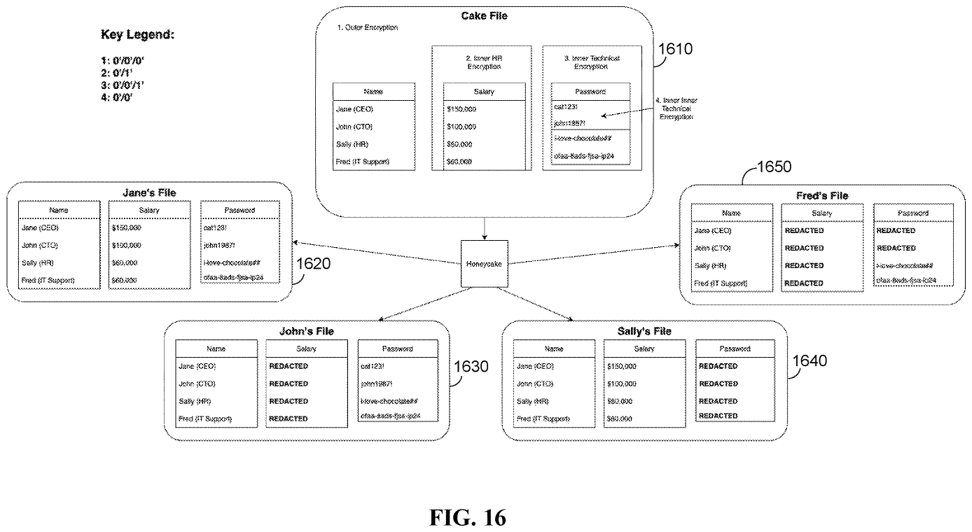

An illustrative example of the multiple views of an encrypted file by different users based on different combinations of cryptographic keys and user authentication information is shown in FIG. 16.

Turning to FIG. 16, FIG. 16 provides an illustrative example in which there is one file 1610 for encryption that has an outer encryption layer and multiple inner encryption layers (e.g., salary information in a human resources section and password information in a technical section) and multiple decrypted file views for different users (e.g., decrypted file 1620 for a viewing user having the user identifier “Jane,” decrypted file 1630 for a viewing user having the user identifier “John,” decrypted file 1640 for a viewing user having the user identifier “Sally,” and decrypted file 1650 for a viewing user having the user identifier “Fred”).

In continuing this example, the creator user has selected file 1610 for encryption and has indicated by identifying content portions (e.g., the salary information in the human resources section and the password information in the technical section) and access information corresponding to each content portion—e.g., user “Jane” can view all content in file 1610, user “John” can view all content in file 1610 except for the salary information in the human resources section, user “Sally” can view all content in file 1610 except for the password information in the technical section, and user “Fred” can view all content in file 1610 except for the salary information in the human resources section and except for the password information corresponding to user “Jane” and user “John” in the technical section. Accordingly, the encryption application executing on the computing device associated with a creator user can encrypt the entire file 1610 with a cryptographic key located at 0′/0′/0′, can encrypt the salary column in the human resources section of the file with a cryptographic key located at 0′/1′, can encrypt the password column in the technical section of the file with a cryptographic key located at 0′/0′, and can encrypt the password information corresponding to user “Jane” and user “John” in the technical section of the file with a cryptographic key located at 0′/0′/1′.

In response to receiving a checksum of the encrypted file and user authentication information (e.g., an email address or other identifier corresponding to users “Jane,” “John,” “Sally,” or “Fred”) and in response to the key database connected to the encryption server matching the checksum received from an encryption application with the checksum of file 1610 that was previously stored in the key database in response to receiving a request for a master key and one or more additional cryptographic keys that can be derived from the master key from a creator user that is encrypting the file at a computing device, the encryption server can determine which cryptographic keys to transmit to the user attempting to open and/or decrypt file 1610.

For example, as shown in view 1620, the encryption server can determine that user “Jane” should receive the 0′ cryptographic key, where the 0′ cryptographic key can derive the 0′/0′/0′ cryptographic key to open file 1610, where the 0′ cryptographic key can derive the 0′/1′ cryptographic key to access the salary column in the human resources section of the file, where the 0′ cryptographic key can derive the 0′/0′/1′ cryptographic key to access the password column in the technical section of the file, and where the 0′ cryptographic key can derive the 0′/0′ key to access the password information corresponding to user “Jane” and user “John” in the technical section of the file.

In another example, as shown in view 1630, the encryption server can determine that user “John” should receive the 0′/0′ key, where the 0′/0′ cryptographic key can derive the 0′/0′/0′ cryptographic key to open file 1610, where the 0′/0′ cryptographic key can derive the 0′/0′/1′ cryptographic key to access the password column in the technical section of the file, and where the 0′/0′ cryptographic key can provide access to the password information corresponding to user “Jane” and user “John” in the technical section of the file. As also shown in view 1630 of FIG. 16, user “John” has not received cryptographic keys that provide access to the salary information in the human resources section of file 1610 and, as such, the salary information in the human resources section is visually indicated as being redacted from view.

In yet another example, as shown in view 1640, the encryption server can determine that user “Sally” should receive the 0′/1′ and the 0′/0′/0′ cryptographic keys, where the 0′/0′/0′ cryptographic key can open file 1610 and where the 0′/1′ cryptographic key can provide access to the salary column in the human resources section of the file. As also shown in view 1640 of FIG. 16, user “Sally” has not received cryptographic keys that provide access to the password column in the technical section of the file 1610 and, as such, the password column in the technical section is visually indicated as being redacted from view.

In a further example, as shown in view 1650, the encryption server can determine that user “Fred” should receive the 0′/0′/1′ and the 0′/0′/0′ cryptographic keys, where the 0′/0′/0′ cryptographic key can open file 1610 and where the 0′/0′/1′ cryptographic key can provide access to the password column in the technical section of the file but not the password information corresponding to user “Jane” and user “John” in the technical section. As also shown in view 1650 of FIG. 16, user “Fred” has not received cryptographic keys that provide access to the salary information in the human resources section of file 1610 and not the password information corresponding to user “Jane” and user “John” in the technical section of file 1610 and, as such, the salary information in the human resources section and the corresponding passwords in the password column in the technical section are visually indicated as being redacted from view.

It should be noted that the encryption server using hierarchically deterministic encryption technique can store one cryptographic key within the key database (e.g., cryptographic key 0′) and transmit a minimum number of keys to each authorized user—e.g., cryptographic key 0′ to user “Jane,” cryptographic key 0′/0′ to user “John,” cryptographic keys 0′/1′ and 0′/0′/0′ to user “Sally,” and cryptographic keys 0′/0′/1′ and the 0′/0′/0′ to user “Fred.” This can, for example, allow the encryption server to minimize key storage, minimize administrative overhead of cryptographic keys, and/or minimize cryptographic processing needs.

Alternatively, in some embodiments, the encryption server can store all of the paths of all of encryption in the key database of the encryption server and can derive the necessary cryptographic keys on the encryption server to transmit to the authorizer user. This can, for example, alleviate the possible derivation of different cryptographic keys by different client environments.

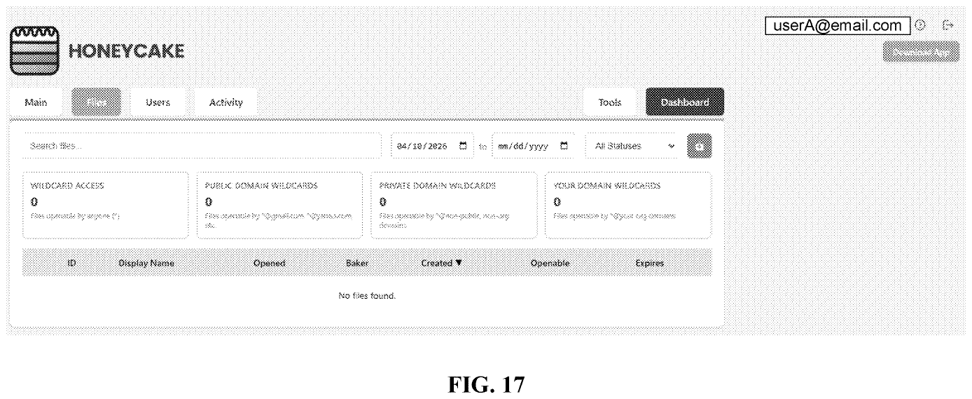

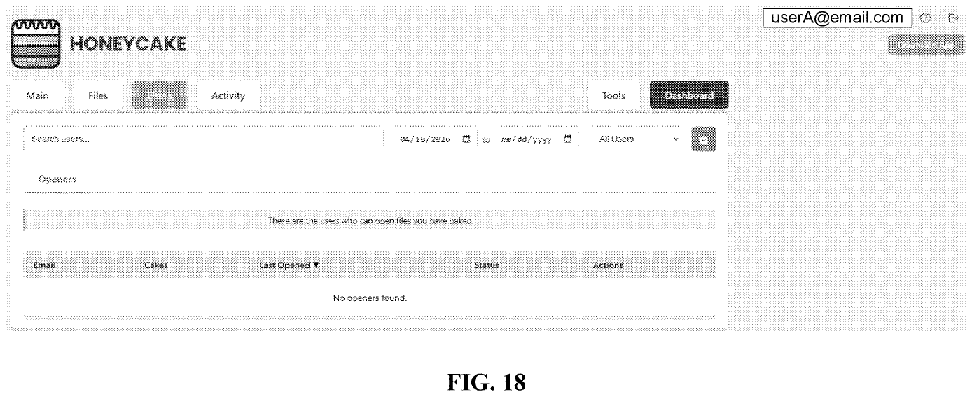

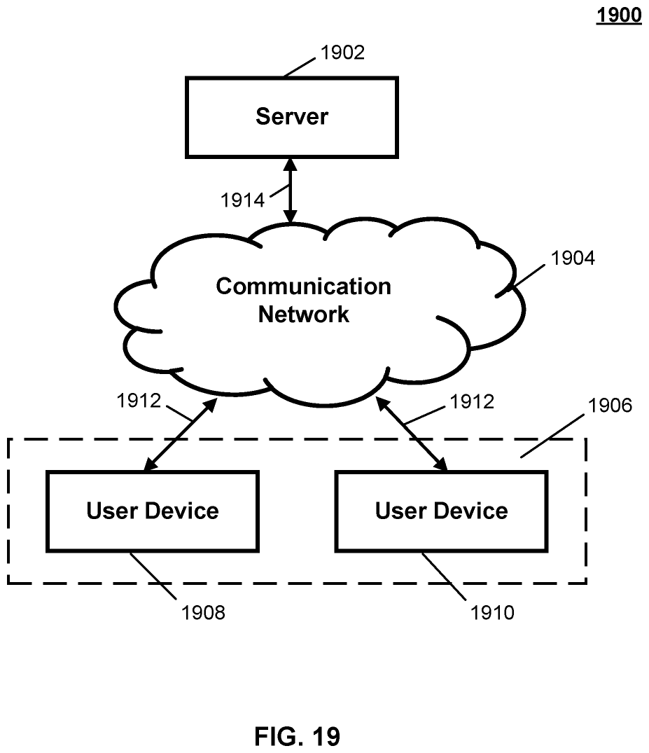

Although the embodiments described herein generally show user interfaces for encrypting and decrypting particular files, any suitable user interface can be presented to a user of the encryption application. For example, FIG. 17 shows an illustrative dashboard user interface in which a user can view files that have been baked or encrypted by the user and files that have been unbaked or decrypted by the user (and received from another user) along with additional file information (e.g., file name, file identifier, creation date, last opened date, access expiration date, etc.). In another example, FIG. 18 shows an illustrative dashboard user interface in which a user can view user information that have access to files baked or otherwise encrypted by the user along with activity information associated with the user information (e.g., user name, email address, files received, last opened date, status information, action information, etc.).

Turning to FIG. 19, an example 1900 of hardware for encrypting a file with granular access control features by a creator user and/or for decrypting and opening at least a portion of the encrypted file by a viewing user in accordance with some implementations is shown. As illustrated, hardware 1900 can include a server 1902, a communication network 1904, and/or one or more user devices 1906, such as user devices 1908 and 1910.

Server 1902 can be any suitable server(s) for storing information, data, programs, media content, and/or any other suitable content. In some implementations, server 1902 can perform any suitable function(s).

Communication network 1904 can be any suitable combination of one or more wired and/or wireless networks in some implementations. For example, communication network can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 1906 can be connected by one or more communications links (e.g., communications links 1912) to communication network 1904 that can be linked via one or more communications links (e.g., communications links 1914) to server 1902. The communications links can be any communications links suitable for communicating data among user devices 1906 and server 1902 such as network links, dial-up links, wireless links, hard-wired links, any other suitable communications links, or any suitable combination of such links.

User devices 1906 can include any one or more user devices suitable for use with process 100, process 400, process 500, process 600, process 800, process 1200, and/or process 1300. In some implementations, user device 1906 can include any suitable type of user device, such as speakers (with or without voice assistants), mobile phones, tablet computers, wearable computers, headsets, laptop computers, desktop computers, smart televisions, media players, game consoles, vehicle information and/or entertainment systems, and/or any other suitable type of user device.

Although server 1902 is illustrated as one device, the functions performed by server 1902 can be performed using any suitable number of devices in some implementations. For example, in some implementations, multiple devices can be used to implement the functions performed by server 1902.

Although two user devices 1908 and 1910 are shown in FIG. 19 to avoid overcomplicating the figure, any suitable number of user devices, (including only one user device) and/or any suitable types of user devices, can be used in some implementations.

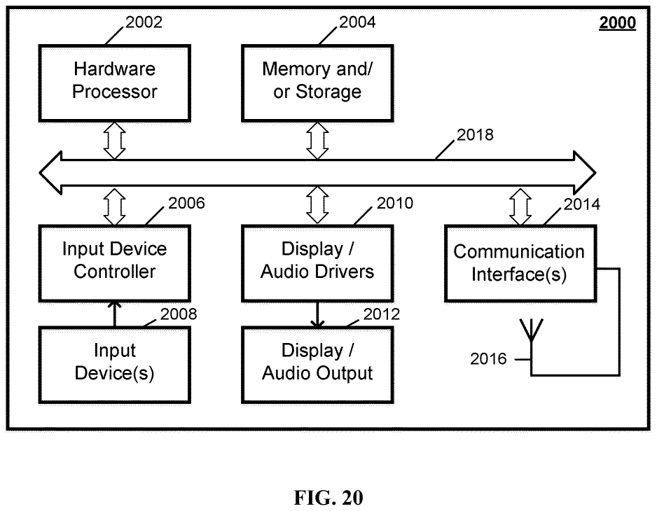

Server 1902 and user devices 1906 can be implemented using any suitable hardware in some implementations. For example, in some implementations, devices 1902 and 1906 can be implemented using any suitable general-purpose computer or special-purpose computer and can include any suitable hardware. For example, as illustrated in example hardware 2000 of FIG. 20, such hardware can include hardware processor 2002, memory and/or storage 2004, an input device controller 2006, an input device 2008, display/audio drivers 2010, display and audio output circuitry 2012, communication interface(s) 2004, an antenna 2016, and a bus 2018.

Hardware processor 2002 can include any suitable hardware processor, such as a microprocessor, a micro-controller, digital signal processor(s), dedicated logic, and/or any other suitable circuitry for controlling the functioning of a general-purpose computer or a special-purpose computer in some implementations. In some implementations, hardware processor 2002 can be controlled by a computer program stored in memory and/or storage 2004. For example, in some implementations, the computer program can cause hardware processor 2002 to perform functions described herein.

Memory and/or storage 2004 can be any suitable memory and/or storage for storing programs, data, documents, and/or any other suitable information in some implementations. For example, memory and/or storage 2004 can include random access memory, read-only memory, flash memory, hard disk storage, optical media, and/or any other suitable memory.

Input device controller 2006 can be any suitable circuitry for controlling and receiving input from one or more input devices 2008 in some implementations. For example, input device controller 2006 can be circuitry for receiving input from a virtual reality headset, a touchscreen, from a keyboard, from a mouse, from one or more buttons, from a voice recognition circuit, from one or more microphones, from a camera, from an optical sensor, from an accelerometer, from a temperature sensor, from a near field sensor, and/or any other type of input device.

Display/audio drivers 2010 can be any suitable circuitry for controlling and driving output to one or more display/audio output devices 2012 in some implementations. For example, display/audio drivers 2010 can be circuitry for driving a display in a virtual reality headset, a heads-up display, a touchscreen, a flat-panel display, a cathode ray tube display, a projector, a speaker or speakers, and/or any other suitable display and/or presentation devices.

Communication interface(s) 2014 can be any suitable circuitry for interfacing with one or more communication networks, such as network 2004 as shown in FIG. 20. For example, interface(s) 2014 can include network interface card circuitry, wireless communication circuitry, and/or any other suitable type of communication network circuitry.

Antenna 2016 can be any suitable one or more antennas for wirelessly communicating with a communication network (e.g., communication network 1904) in some implementations. In some implementations, antenna 2016 can be omitted.

Bus 2018 can be any suitable mechanism for communicating between two or more components 2002, 2004, 2006, 2010, and 2014 in some implementations.

Any other suitable components can be included in hardware 2000 in accordance with some implementations.

In some implementations, any suitable computer readable media can be used for storing instructions for performing the functions and/or processes described herein. For example, in some implementations, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that at least some of the above-described blocks of process 100, process 400, process 500, process 600, process 800, process 1200, and/or process 1300 can be executed or performed in any order or sequence not limited to the order and sequence shown in and described in connection with FIGS. 1, 4-6, 8, 12, and 13. Also, some of the above blocks of process 100, process 400, process 500, process 600, process 800, process 1200, and/or process 1300 can be executed or performed substantially simultaneously where appropriate or in parallel to reduce latency and processing times. Additionally or alternatively, some of the above described blocks of process 100, process 400, process 500, process 600, process 800, process 1200, and/or process 1300 can be omitted.

Accordingly, secure file sharing methods, systems, and media including granular access control features based on user authentication in unsecure computing environments are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for securely encrypting data containers in an unsecure environment, the method comprising:
receiving an encryption request for a file during an artificial intelligence session, wherein a server provides an interface between an encryption service and an artificial intelligence model and wherein the server is configured to allow a plurality of encryption operations performed by the encryption service to be called by the artificial intelligence model;
determining a token associated with the artificial intelligence session between a local computing device and the artificial intelligence model;
exchanging the token associated with the artificial intelligence session between the local computing device and the artificial intelligence model with an encryption-service-scoped token from the encryption service;
transmitting, to the encryption service, a request for a plurality of hierarchically deterministic cryptographic keys that are derived from the encryption-service-scoped token, wherein each of the plurality of hierarchically deterministic cryptographic keys corresponds with a content portion identified as needing internal encryption and wherein the content portion is associated with user access information; and
encrypting the content portion of the file associated with the artificial intelligence session using at least one of the plurality of hierarchically deterministic cryptographic keys that are derived from the encryption-service-scoped token.

2. The method of claim 1, wherein the content portion identified as needing internal encryption with a hierarchically deterministic cryptographic key from the plurality of hierarchically deterministic cryptographic keys further comprises:
extracting structured content from the file;
detecting, using a machine learning model that executes a named entity recognition technique, that the content portion contains content that is deemed to be sensitive content;
classifying, using a large language model, the content within the detected content portion using a context-aware sensitivity assessment; and
comparing the classified content against organization-specific policies to obtain evaluated content.

3. The method of claim 2, wherein the method further comprises:
generating a recommended encryption layer for further encrypting the file based on the evaluated content; and
assigning a hierarchically deterministic key path for the content portion based on the recommended encryption layers, wherein the hierarchically deterministic cryptographic key used to encrypt the content portion is located at the hierarchically deterministic key path.

4. The method of claim 1, wherein the content portion identified as needing internal encryption with a hierarchically deterministic cryptographic key from the plurality of hierarchically deterministic cryptographic keys further comprises:
rendering document content associated with at least a portion of the file on an interactive canvas interface;
receiving user input defining a spatial region within the rendered document content presented on the interactive canvas interface;
generating a redaction manifest that maps the spatial region to a hierarchically deterministic key path, wherein the hierarchically deterministic cryptographic key used to encrypt the spatial region is located at the hierarchically deterministic key path.

5. The method of claim 1, wherein the method further comprises providing a markup language that receives a plurality of arbitrary markers that are placed within the file by a user of the local computing device, wherein the plurality of arbitrary markers indicate a starting point and an ending point of a layer of internal encryption within the file.

6. The method of claim 5, wherein each of the plurality of arbitrary markers includes a first sequence of characters to indicate the starting point of the layer of internal encryption and a second sequence of characters to indicate the ending point of the layer of internal encryption.

7. The method of claim 1, wherein the method further comprises receiving an indication from a user of the local computing device of a layer of internal encryption within the file.

8. The method of claim 1, wherein the content portion identified as needing internal encryption with a hierarchically deterministic cryptographic key from the plurality of hierarchically deterministic cryptographic keys further comprises identifying content portions based on file type for at least one of page-level encryption, slide-level encryption, and field-level encryption.

9. The method of claim 1, wherein the user access information associated with a content portion within the file needing internal encryption is at least one of: a user identifier, an email address, a domain wildcard that identifies users at a domain, a universal wildcard that identifies authenticated users, and an organization group that identifies users associated with a group within an organization.

10. The method of claim 1, wherein the user access information associated with a content portion within the file needing internal encryption includes a deny rule that indicates users that are denied access to the content portion.

11. The method of claim 1, wherein each of the plurality of hierarchically deterministic cryptographic keys that are derived from the encryption-service-scoped token is wrapped by a key encryption key to form a wrapped key and wherein the wrapped key is bound to an organization, the file that includes the content portion, and a field associated with the content portion based on additional authenticated data.

12. The method of claim 1, wherein the method further comprises transmitting user authentication information to an encryption server corresponding to the encryption service to initiate the encryption of the file.

13. The method of claim 12, wherein the user authentication information includes at least one of: an email address, a password, a personal identification number, a biometric credential, a magic link for passwordless email-based login, and a federated identity token.

14. The method of claim 1, wherein the encryption-service-scoped token is generated using a hierarchically deterministic encryption technique and acts as a master key.

15. The method of claim 14, wherein the method further comprises encrypting, using the hierarchically deterministic encryption technique, the file using the master key.

16. The method of claim 1, wherein the method further comprises transmitting file information to the server that is associated with the encryption-service-scoped token corresponding to the encrypted file, wherein the file information includes a fingerprint of the file, a file name associated with the file, the encryption-service-scoped token that was received from the encryption server, a time-to-live value associated with the file, and an access tree corresponding to the one or more layers of internal encryption associated with the file and wherein the file information and the encryption-service-scoped token are associated in a key database associated with the server.

17. The method of claim 16, wherein the fingerprint of the file is a checksum of the file generated by the local computing device.

18. A system for securely encrypting data containers in an unsecure environment, the system comprising:
a hardware processor that is configured to:
receive an encryption request for a file during an artificial intelligence session, wherein a server provides an interface between an encryption service and an artificial intelligence model and wherein the server is configured to allow a plurality of encryption operations performed by the encryption service to be called by the artificial intelligence model;
determine a token associated with the artificial intelligence session between a local computing device and the artificial intelligence model;
exchange the token associated with the artificial intelligence session between the local computing device and the artificial intelligence model with an encryption-service-scoped token from the encryption service;
transmit, to the encryption service, a request for a plurality of hierarchically deterministic cryptographic keys that are derived from the encryption-service-scoped token, wherein each of the plurality of hierarchically deterministic cryptographic keys corresponds with a content portion identified as needing internal encryption and wherein the content portion is associated with user access information; and
encrypt the content portion of the file associated with the artificial intelligence session using at least one of the plurality of hierarchically deterministic cryptographic keys that are derived from the encryption-service-scoped token.

19. A non-transitory computer-readable medium containing computer executable instructions that, when executed by a processor, cause the processor to perform a method for securely encrypting data containers in an unsecure environment, the method comprising:
receiving an encryption request for a file during an artificial intelligence session, wherein a server provides an interface between an encryption service and an artificial intelligence model and wherein the server is configured to allow a plurality of encryption operations performed by the encryption service to be called by the artificial intelligence model;
determining a token associated with the artificial intelligence session between a local computing device and the artificial intelligence model;
exchanging the token associated with the artificial intelligence session between the local computing device and the artificial intelligence model with an encryption-service-scoped token from the encryption service;
transmitting, to the encryption service, a request for a plurality of hierarchically deterministic cryptographic keys that are derived from the encryption-service-scoped token, wherein each of the plurality of hierarchically deterministic cryptographic keys corresponds with a content portion identified as needing internal encryption and wherein the content portion is associated with user access information; and
encrypting the content portion of the file associated with the artificial intelligence session using at least one of the plurality of hierarchically deterministic cryptographic keys that are derived from the encryption-service-scoped token.
